(19) United States
(12) Patent Application Publication
(10) Pub. No.: US 2010/0207511 A1
(43) Pub. Date: Aug. 19, 2010

(54) SEMICONDUCTOR LIGHT EMITTING DEVICE

(76) Inventor: Mitsunori Harada, Tokyo (JP)

Correspondence Address: KENEALY VAIDYA LLP, 515 EAST BRADDOCK RD SUITE B, Alexandria, VA, 22314, US

(21) Appl. No.: 12/707,474

(22) Filed: Feb. 17, 2010

(30) Foreign Application Priority Data
Feb. 19, 2009 (JP) 2009-036971
Feb. 19, 2009 (JP) 2009-036972

(51) Int. Cl. H01J 1/62

(52) U.S. Cl. 313/501

(57) ABSTRACT

A light emitting device is provided in which fluorescence emitted from each phosphor in the color conversion plate containing multiple types of phosphors is hard to be absorbed by the other phosphor, and the light from the light emitting element is allowed to reach each of the phosphors efficiently. The color conversion plate has a sea-island structure including a sea region and an island region, and the island region contains the first phosphor and the sea region contains the second phosphor. The fluorescent wavelength of the first phosphor is longer than the fluorescent wavelength of the second phosphor. With the sea-island structure as described above, the contact area between the region containing the first phosphor and the region containing the second phosphor is reduced. The fluorescence of the second phosphor is hard to be absorbed by the first phosphor which has a longer wavelength.

This application claims the priority benefit under 35 U.S.C. §119 of Japanese Patent Application No. 2009-036971 filed on Feb. 19, 2009 and Japanese Patent Application No. 2009-036972 filed on Feb. 19, 2009, which are both hereby incorporated in their entireties by reference.

### FIELD OF THE INVENTION

The present invention relates to a semiconductor light emitting device provided with a member which subjects an outgoing beam from a semiconductor light emitting element to wavelength conversion.

### DESCRIPTION OF THE RELATED ART

There is known a light emitting element which is formed by arranging two or more types of phosphor layers on the semiconductor light emitting element and converts the light from the semiconductor light emitting element into light having two or more wavelengths, thereby outputting light which is generated by mixing these various types of light.

By way of example, Japanese Unexamined Patent Application Publication No. 2004-179644 (hereinafter referred to as “patent document 1”) and Japanese Unexamined Patent Application Publication No. 2005-277127 (hereinafter referred to as “patent document 2”) disclose a structure including two or more phosphor layers being laminated on a semiconductor light emitting element. The two or more phosphor layers absorb light from the semiconductor light emitting element and emit fluorescence having a predetermined wavelength. On this occasion, the laminate order of the phosphor layers is configured in such a manner that a layer arranged closer to the semiconductor light emitting element emits the fluorescent having a longer wavelength. Specifically, a red phosphor layer for outputting red fluorescent and a green phosphor layer for outputting green fluorescent are laminated in this order on the semiconductor element which outputs blue light. With this laminate order, the red fluorescence outputted from the red phosphor layer is not absorbed by the green phosphor layer arranged thereon, and therefore, it is possible to acquire high luminous intensity.

Japanese Unexamined Patent Application Publication No. 2007-134656 (hereinafter, referred to as “patent document 3”) discloses a light emitting device in which a plate-like member made up of three phosphor layers being laminated is arranged on a light emitting element which emits ultraviolet radiation. The layers of three-layer phosphor absorb the ultraviolet radiation, and emit red, green, and blue fluorescence respectively, being arranged in this order from the light emitting element side, so that white light is outputted, which is obtained by mixing the three colors. Since the three layers are arranged in such a manner as described above, the fluorescence emitted from each of the phosphor layers is not absorbed by the other phosphor layer arranged thereon, and it is possible to enhance light extraction efficiency.

Japanese Patent No. 4123057 (hereinafter, referred to as “patent document 4”) discloses a structure in which a color converting material is arranged on the light emitting element, and in-plane concentration distribution of the color converting material is decreased along the direction from the center to the outer periphery, in order to solve a problem that brightness unevenness or color unevenness may occur according to the observation angle. Specifically, the patent document 4 discloses a structure in which grooves are provided on a transparent member, and the grooves are filled with a phosphor. Here, the depth of the groove is made to be shallower as it becomes closer to the outer periphery, or a distance between the grooves is made to be larger as it becomes closer to the outer periphery.

Japanese Unexamined Patent Application Publication No. 2008-258171 (hereinafter, referred to as “patent document 5”) discloses a wavelength convertor is configured in which cells made of red, green, and blue phosphors respectively are spread in planar state, in such a manner that those three phosphors do not overlap one another in the optical path direction, and the fluorescence generated from each phosphor is not absorbed by the other phosphor.

Any of the configurations disclosed in the aforementioned patent documents 1, 2, and 3 are directed to suppress a problem, i.e., when an absorption edge of the red phosphor is located at a longer wavelength side than the green wavelength, and the red phosphor layer is placed on the upper side of the green phosphor layer, green light emitted from the green phosphor layer is absorbed by the red phosphor layer, whereby the luminous intensity is lowered. However, in the semiconductor light emitting device with such configuration as described above, most of the light outputted from the light emitting element, e.g., a blue light emitting element, is absorbed by the red phosphor layer arranged on the element side, and only a part of the light having not been absorbed is allowed to reach the green light emitting phosphor layer, and subjected to the wavelength conversion. Therefore, there is a problem that the light outputted from the semiconductor light emitting element cannot be utilized efficiently as exciting light.

Similarly, in order to obtain white color by mixing colors, if it is structured such that the light emitting element which outputs ultraviolet radiation is used, and the phosphor layers made up of three layers; blue, green, and red, are laminated thereon, most of the ultraviolet radiation from the light emitting element is absorbed by the green and red phosphors. Therefore, the intensity of the ultraviolet radiation which reaches the blue phosphor is reduced, causing poor efficiency in wavelength conversion.

The technique described in the patent document 4 adjusts the in-plane concentration distribution of the color conversion material in order to reduce brightness unevenness according to the observation angle. However, in here, the phosphor being used is just one type, and this does not solve the problem that exciting light or fluorescence is absorbed between multiple phosphors.

The technique described in the patent document 5 includes the color conversion material in which cells made of three types of phosphors are spread in planar state. However, since the wavelengths of the fluorescence emitted from the respective cells are different from one another, there is a possibility that chromatic unevenness may occur in the in-plane direction.

An aspect of the present invention is to provide alight emitting device, in which fluorescence outputted from each of phosphors of the color conversion plate containing multiple types of phosphors, is hard to be absorbed by the other phosphor, and the light from the light emitting element is allowed to reach each of the phosphors efficiently.

### SUMMARY OF THE INVENTION

According to the first aspect of the present invention, the semiconductor light emitting device as the following is provided. In other words, the semiconductor light emitting device includes a light emitting element, and a color conversion plate being mounted on the light emitting element, the color conversion plate containing at least a first phosphor and a second phosphor which absorb light emitted from the light emitting element and output fluorescence, wherein the color conversion plate has a sea-island structure including a sea region and an island region which is scattered in the sea region. The island region contains the first phosphor, and the sea region contains the second phosphor. With this sea-island structure, a contact area between the region containing the first phosphor and the region containing the second phosphor is reduced, whereby it is possible to suppress a phenomenon in which the fluorescence outputted from one phosphor is absorbed by the other phosphor. Therefore, the color conversion efficiency can be improved.

It is preferable that a fluorescent wavelength of the first phosphor is longer than the fluorescent wavelength of the second phosphor. Accordingly, most of the fluorescence having the short wavelength, which is emitted from the second phosphor, is outputted externally through the sea region, without passing through the island region.

It is preferable that a part of the island region is exposed on a surface of the color conversion plate on the light emitting element side. With this configuration, it is possible to allow the light from the light emitting element to directly enter both the sea region and the island region, and therefore the light can be utilized efficiently as the exciting light.

For example, the island region has a structure being convex shape in the upward direction with respect to the upper surface of the light emitting element, where an upper portion of the convex shape is embedded in the sea region and a bottom of the convex shape is exposed on the surface of the color conversion plate on the light emitting element side. With this structure, the fluorescence emitted from the island region is allowed to enter the sea region efficiently, and then outputted externally. For example, in a specific structure, the island region can be shaped like a hemisphere, and a curved portion of the hemisphere is embedded in the sea region, and the bottom portion of the hemisphere is exposed on the surface of the color conversion plate on the light emitting element side.

Alternatively, for example, it is structure such that the island region is shaped like a sphere, and a portion of the sphere is embedded in the sea region and the other portion is exposed from the surface of the color conversion plate on the light emitting element side. With the structure as described above, the light outputted from the light emitting element enters the island region exposed to the light emitting element side with a high degree of efficiency, and therefore, it is possible to enhance the light emitting efficiency in the island region.

Further alternatively, for example, the island region has a structure having a convex shape facing to the light emitting element from the surface of the color conversion plate on the light emitting element side, and the bottom of the convex shape is fixed on the surface of the color conversion plate on the light emitting element side. With this structure, the light outputted from the light emitting element enters the island region with a high degree of efficiency and a contact area between the sea region and the island region is reduced, whereby it is possible to suppress a phenomenon in which the fluorescence generated in any of the regions is absorbed by the phosphor in the other region. For example, in a specific structure, the island region is shaped like a hemisphere, a bottom of the hemisphere is fixed on the surface of the color conversion plate on the light emitting element side, and the curved portion of the hemisphere shape protrudes toward the light emitting element.

In the structure where the island region protrudes from the color conversion plate, preferably, there is arranged between the color conversion plate and the light emitting element, a transparent adhesion layer made of a material being transparent at least against the light emitted from the light emitting element, and the transparent adhesion layer is configured in such a manner that the thickness thereof is equal to or larger than the height of the island region which protrudes from the sea region of the color conversion plate toward the light emitting element side.

It is further possible to configure such that a second island region containing a third phosphor is scattered in the sea region. Preferably, the fluorescent wavelength of the third phosphor is shorter than the fluorescent wavelength of the first phosphor.

It is also preferable to locate the center of the second island region containing the third phosphor in the principal plane direction of the color conversion plate in such a manner as being displaced from the center of the island region containing the first phosphor. This configuration allows the light from the light emitting element to reach the third phosphor efficiently.

By way of example, the second island region is configured so that a part thereof is exposed on the surface which is opposed to the surface of the color conversion plate on the light emitting element side. With the configuration above, even when the fluorescent wavelength of the third phosphor is shorter than the fluorescent wavelength of the second phosphor, it is possible to output the fluorescence of the third phosphor having the short wavelength, directly to the outside.

For example, the second island region may have a structure shaped like a hemisphere, a curved portion of the hemisphere is embedded in the sea region, and the bottom portion of the hemisphere is exposed on the surface being opposed to the surface of the color conversion plate on the light emitting element side.

By way of example, the semiconductor light emitting element emits blue light, the first phosphor absorbs the blue light and emits red fluorescence, and the second phosphor absorbs the blue light and emits green fluorescence. Accordingly, white light can be emitted.

Alternatively, for example, the semiconductor light emitting element emits ultraviolet radiation, the first phosphor absorbs the ultraviolet radiation and emits red fluorescence, the second phosphor absorbs the ultraviolet radiation and emits green fluorescence, and the third phosphor absorbs the ultraviolet radiation and emits blue fluorescence. Accordingly, white light can be emitted.

According to the second aspect of the present invention, a semiconductor light emitting device as the following will be provided. In other words, the semiconductor light emitting device includes a light emitting element, and a color conversion plate being mounted on the light emitting element, the color conversion plate containing at least a first phosphor and a second phosphor which absorb light emitted from the light emitting element and output fluorescence, wherein the color conversion plate has a sea-island structure including a sea region and an island region which is scattered in the sea region. The island region penetrates into the color conversion plate in the thickness direction, and a part thereof is exposed on the upper surface and the lower surface of the color conversion plate. The island region contains the first phosphor, and the sea region contains the second phosphor. Since the color conversion plate has the sea region and the island region being exposed both on the surface on the light emitting element side and the upper surface, it is possible to excite the respective phosphors simultaneously by the light from the light emitting element, further allowing the fluorescence to be directly outputted from the upper surface, thereby enhancing the color conversion efficiency.

Preferably, the fluorescent wavelength of the first phosphor is longer than the fluorescent wavelength of the second phosphor. Since the island region contains the first phosphor having a longer wavelength, it is hard for the first phosphor to absorb the fluorescence of the second phosphor having the shorter wavelength, and therefore unevenness in color can be reduced.

It is further possible to configure the sea region in such a manner that it contains a third phosphor in addition to the first phosphor. Preferably, the fluorescent wavelength of the third phosphor is shorter than the first fluorescent wavelength. With this configuration, three-color fluorescence can be emitted by the color conversion plate.

Alternatively, it is possible to configure such that a second island region containing the third phosphor is arranged, being scattered in the sea region, aside from the island region which contains the first phosphor. Preferably, the fluorescence wavelength of the third phosphor is shorter than the first fluorescent wavelength.

By way of example, the semiconductor light emitting element emits blue light, the first phosphor absorbs the blue light and emits red fluorescence, and the second phosphor absorbs the blue light and emits green fluorescence.

By way of example, it is further possible that the semiconductor light emitting element emits ultraviolet radiation, the first phosphor absorbs the ultraviolet radiation and emits red fluorescence, the second phosphor absorbs the ultraviolet radiation and emits green fluorescence, and the third phosphor absorbs the ultraviolet radiation and emits blue fluorescence.

### BRIEF DESCRIPTION OF THE DRAWINGS

FIG. 1(a) illustrates a sectional view and FIG. 1(b) illustrates a top view of a flip-chip type semiconductor light emitting device according to the first embodiment;

FIG. 2 is a sectional view of a color conversion plate 5 of the semiconductor light emitting device as shown in FIG. 1;

FIG. 3 is a graph showing an absorption spectrum and a fluorescent spectrum of a red phosphor and a green phosphor according to the first embodiment;

FIG. 4(a) to FIG. 4(c) illustrate a production process of the color conversion plate 5 according to the first embodiment;

FIG. 5(a) illustrates a sectional view and FIG. 5(b) illustrates a top view of a metal-bonding type semiconductor light emitting device according to the second embodiment;

FIG. 6 illustrates a position where a large-area plate is cut out and a shape of a notch 58 in a process for producing the color conversion plate 5 as shown in FIG. 5;

FIG. 7A illustrates a sectional view of a flip-chip type semiconductor light emitting device according to the third embodiment;

FIG. 7B illustrates a sectional view of a metal-bonding type semiconductor light emitting device according to the third embodiment;

FIG. 8(a) to FIG. 8(c) illustrate a production process of the color conversion plate 5 according to the third embodiment;

FIG. 9A illustrates a sectional view of a flip-chip type semiconductor light emitting device according to the fourth embodiment;

FIG. 9B illustrates a sectional view of a metal-bonding type semiconductor light emitting device according to the fourth embodiment;

FIG. 10(a) to FIG. 10(c) illustrate a production process of the color conversion plate 5 according to the fourth embodiment;

FIG. 11(a) illustrates a sectional view and FIG. 11(b) illustrates a top view of a flip-chip type semiconductor light emitting device according to the fifth embodiment;

FIG. 12 is a sectional view of a color conversion plate 50 of the semiconductor light emitting device as shown in FIG. 11;

FIG. 13 is a graph showing the absorption spectrum and the fluorescent spectrum of the red phosphor, the green phosphor, and a blue phosphor according to the fifth embodiment;

FIG. 14(a) to FIG. 14(d) illustrate a production process of the color conversion plate 5 according to the fifth embodiment;

FIG. 15(a) illustrates a sectional view and FIG. 15(b) illustrates a top view of the metal-bonding type semiconductor light emitting device according to the fifth embodiment;

FIG. 16A illustrates a sectional view of a flip-chip type semiconductor light emitting device according to the sixth embodiment;

FIG. 16B illustrates a sectional view of a metal-bonding type semiconductor light emitting device according to the sixth embodiment;

FIG. 17(a) to FIG. 17(d) illustrate a production process of the color conversion plate 50 according to the sixth embodiment;

FIG. 18A is a sectional view of a flip-chip type semiconductor light emitting device according to the seventh embodiment,

FIG. 18B illustrates a sectional view of a metal-bonding type semiconductor light emitting device according to the seventh embodiment;

FIG. 19(a) illustrates a sectional view and FIG. 19(b) illustrates a top view of a flip-chip type semiconductor light emitting device according to the eighth embodiment;

FIG. 20(a) illustrates a sectional view of the color conversion plate 5 of the semiconductor light emitting device as shown in FIG. 19 with an explanatory view of the fluorescence being emitted; and FIG. 20(b) illustrates a top view of the color conversion plate 5;

FIG. 21(a) to FIG. 21(c) illustrate a production process of the color conversion plate 5 according to the eighth embodiment; and

FIG. 22(a) illustrates a sectional view and FIG. 22(b) illustrates a top view of a metal-bonding type semiconductor light emitting device according to the tenth embodiment.

### DESCRIPTION OF THE PREFERRED EMBODIMENTS

A light emitting device according to one embodiment of the present invention will be explained with reference to the accompanying drawings.

### First Embodiment

The light emitting device according to the first embodiment is a device for converting a part of blue light outputted from a blue-color light emitting flip-chip element into red light and green light by using a color conversion plate, so as to emit white light which is obtained by mixing the blue, red, and green light.

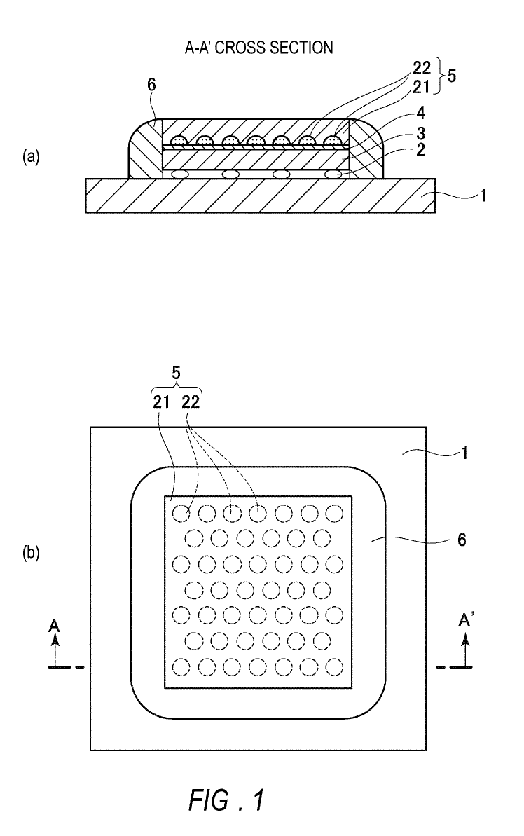

FIG. 1(a) illustrates a sectional view and FIG. 1(b) illustrates a top view of the light emitting device according to the first embodiment. As shown in FIG. 1(a), a flip-chip type semiconductor light emitting element 3 is implemented using Au bumps 2 on a substrate 1 on which electrode and wiring are formed in advance. On the semiconductor light emitting element 3, there is mounted a color conversion plate 5 via a transparent adhesion layer 4. Side surfaces of the semiconductor light emitting element 3 and the color conversion plate 5 are surrounded by an optical reflection frame 6.

The flip-chip type semiconductor light emitting element 3 includes, though not illustrated, an element substrate being transparent to the blue light, and a light emitting layer laminated thereon, and the light emitting layer is arranged on the substrate 1 side, and the element substrate is arranged facing to the color conversion plate 5 side.

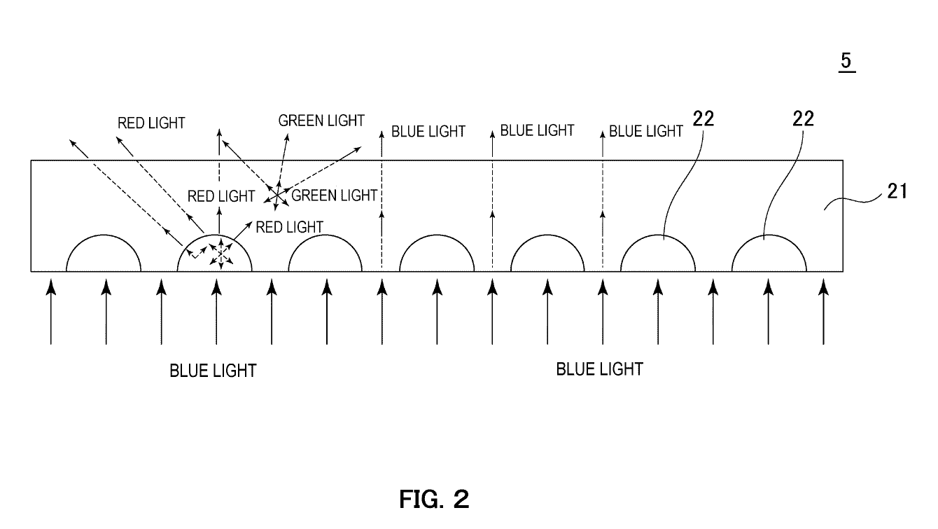

The color conversion plate 5 has a plate-like shape as shown in FIG. 2 which is an enlarged view, and on the surface on the semiconductor light emitting element 3 side, there are provided multiple hemispherical regions 22 being arranged in two dimensions. In the hemispherical region 22, a phosphor is dispersed, which absorbs blue light and emits red colored fluorescence (hereinafter, referred to as “red phosphor”). In the region 21, other than the regions 22 including the red phosphor, another phosphor is dispersed, which absorbs the blue light and emits green fluorescence (hereinafter, referred to as “green phosphor”).

In other words, the color conversion plate 5 is a plate having a sea-island structure where the hemispherical red phosphor region 22 is formed like an island on the surface of the region 21 including the green phosphor (sea region) on the light emitting element 3 side.

For example, CaAlSiN₃:Eu, (Ca,Sr)₂Si₅N₈:Eu, (Ca,Sr)S:Eu may be employed as the red phosphor of the red phosphor region 22, which absorbs blue light and emits red fluorescence. (Ba,Sr)₂SiO₄:Eu, CaSc₂O₄:Ce, (Ca,Sr)Ga₂S₄:Eu, Ca₈MgSi₄O₁₆Cl₂:Eu, and (Si,Al)₆(O,N)₈:Eu may be employed, for example, as the green phosphor of the green phosphor region 21, which absorbs blue light and emits green fluorescence. Preferably, a material used as a base material of the red phosphor region 22 is transparent to the red, green, and blue light, and the material is formable by a printing method. For example, an epoxy resin, a silicone resin, or the like, being a thermosetting resin, may be employed. Preferably, a material used as the base material for dispersing the green phosphor in the green phosphor region 21 is transparent to the red, green, and blue light, and the material is processible into a predetermined shape by injection molding or metallic molding, for instance. A resin or glass may be employed. As a resin it is used such as an epoxy resin, a silicone resin, or a composite resin thereof.

The transparent adhesion layer 4 is a layer made of adhesive agent for bonding the color conversion plate 5 on the semiconductor element 3, and it is made of a material which is at least transparent to blue light.

The optical reflection frame 6 is made of a material which is obtained by dispersing fillers having various reflective indexes in a resin. For example, titanium oxide, aluminum oxide, a barium sulphate, or the like may be appropriately selected as the filler.

In the light emitting device according to the embodiment as described above, the blue light outputted from the light emitting element 3 passes through the transparent adhesion layer 4, and enters the lower surface of the color conversion plate 5 (the surface on the light emitting element 3 side). As shown in FIG. 2, the color conversion plate 5 is configured in such a manner that the red phosphor region 22 are provided like islands on the lower surface of the color conversion plate 5 and the green phosphor region 22 spreads therebetween like the sea. Therefore, the blue light directly enters each of the red phosphor regions 22 and the green phosphor region 21, thereby exciting the phosphors respectively. Accordingly, red fluorescence is emitted from the red phosphor region 22, and green fluorescence is emitted from the green phosphor region 21.

The red fluorescence generated in the island-like red phosphor region 22 of the color conversion plate 5 passes the interface with the green phosphor region 21, enters the green phosphor region 21, and after passing through the green phosphor region 21, the red fluorescence is outputted from the upper surface of the color conversion plate 5. On this occasion, an absorption edge of the absorption spectrum of the green phosphor is located on the shorter wavelength side than the red light wavelength range. Therefore, the red phosphor is allowed to pass through the green phosphor region 21 without being absorbed, and the intensity of the red phosphor is not attenuated.

On the other hand, most of the light going upward, out of the green phosphor generated in the green phosphor region 21 being the sea region, is outputted from the upper surface of the color conversion plate 5 without passing through the red phosphor region 22. Since the absorption edge of the absorption spectrum of the red phosphor partially overlaps the green light wavelength range, the red phosphor absorbs the green phosphor. However, in the present embodiment, the light going upwardly, out of the green fluorescence, is allowed to reach the upper surface of the color conversion plate 5 without passing through the red phosphor region 22. Therefore, the green phosphor can be outputted with little attenuation.

A part of the blue light which is outputted from the light emitting element 3 and enters the color conversion plate 5 transmits the red phosphor region 22 and the green phosphor region 21, then outputted from the upper surface of the color conversion plate 5.

Therefore, the red light, green light, and blue light are mixed to obtain white light, and the white light is outputted from the upper surface of the color conversion plate 5.

Since the optical reflection frame 6 surrounds the side surfaces of the light emitting element 3 and the color conversion plate 5, it is possible to efficiently guide the light, which is outputted from the side surfaces of the transparent substrate of the light emitting element 3, toward the color conversion plate 5. It is further possible to guide the light outputted from the side surfaces of the color conversion plate 5 in the upward direction. Such configuration as described above may enhance color conversion efficiency and light output efficiency of the color conversion plate.

In the present embodiment, a surface on the side provided with the red phosphor region 22 of the color conversion plate 5 having the sea-island structure is placed above the light emitting element 3, facing to the light emitting element 3. Therefore, the blue light emitted from the light emitting element 3 enters the green phosphor region 21 being the sea part and the red phosphor region 22 being the island part respectively, thereby allowing both of the phosphors to be excited within the same incident plane, maximizing the excitation efficiency of the both phosphors.

In addition, the red phosphor region 22 is shaped like a hemisphere, and therefore, the interface with the green phosphor region 21 has a hemispherical shape. Since the fluorescence emitted radially from the phosphor of the island part (red phosphor region 22) enters the interface with the sea part at a right angle or approximately right angle, the light is hardly reflected by the interface and allowed to enter the green phosphor region 21 with a high degree of efficiency. Accordingly, there is an effect that the light extraction efficiency of red fluorescence from the red phosphor region 22 is more enhanced, relative to a conventional structure where a layer of the red phosphor dispersed resin and a layer of the green phosphor dispersed resin are laminated.

Since the red phosphor region 22 has a hemispherical shape being scattered, a contact area with the green phosphor region 21 becomes smaller relative to the conventional laminated structure. Therefore, a phenomenon where the green fluorescence emitted from the green phosphor region 21 is absorbed by the red phosphor can be suppressed drastically. Consequently, efficiency in the wavelength conversion caused by the color mixing is considerably enhanced, relative to the laminated structure.

When the blue light emitted from the light emitting element 3 passes through the green phosphor region 21 being the sea part, in practice, a part of the blue light is subjected to the wavelength conversion by the green phosphor, and becomes blue-green light as mixed-color light. When the blue light passes through the red phosphor region 22 being the island part, a part of the blue light is subjected to the wavelength conversion by the red phosphor, and becomes red-purple light as mixed-color light. Furthermore, the green light and the red light respectively from the green phosphor region 21 being the sea part and the red phosphor region 22 being the island part interfere with each other in the horizontal direction, thereby generating yellow light. As described above, an optic element is decomposed and synthesized, and therefore it is possible to obtain mixed white light extremely homogeneous, with a high degree of efficiency in wavelength conversion.

The light emitting device of the present embodiment is able to adjust an amount of the phosphor contained in the red phosphor region 22 and a size of the hemispherical region, thereby enabling adjustment of the red light intensity. Furthermore, since the adjustment of the size of the hemispherical region may change the amount of the blue light entering the green phosphor region 21, and accordingly, the amount of the green phosphor is also changed. By adjusting the amount of the green phosphor in the green phosphor region 21 and the thickness of the plate 5, the light amount of the green phosphor is also changed and the amount of transmissive blue light is changed as well. Therefore, according to the adjustments as described above, it is possible to change chromaticity and brightness of the white light to a desired value.

It is to be noted that the homogeneity in chromaticity and brightness of the white light is influenced by the diameter of the island-like red phosphor region 22. Therefore, the diameter of the red phosphor region 22 is adjusted so that necessary chromatic homogeneity can be obtained. If one side of the color conversion plate 5 is around 1 mm, it is preferable that the diameter of one red phosphor region 22 is approximately between or equal to 20 μm and 200 μm, since this range enhances the chromatic homogeneity.

The color conversion plate 5 of the present embodiment is obtained by using a general printing method, and one sheet of large-area plate is produced for a large number of pieces being continuous, and individual pieces are cut out, thereby enabling a production of a large number of pieces at one time. Therefore, a color conversion function of each color conversion plate 5 is uniform within an identical lot (an identical large-area plate), and it is possible to considerably enhance yields of the product with less variation in color, compared to a conventional art in which a color conversion material is coated and formed on an individual semiconductor light emitting element.

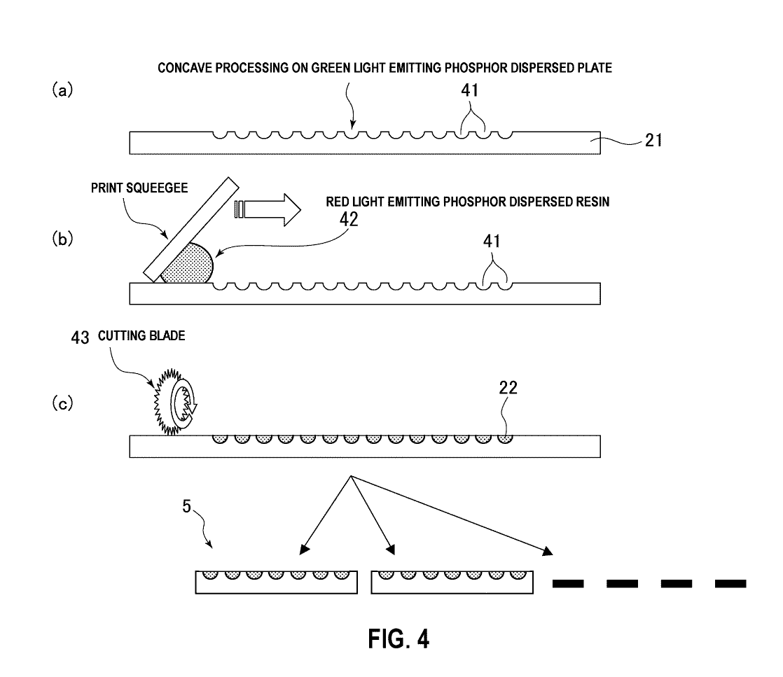

Hereinafter, one example of a method for producing the light emitting device according to the present embodiment will be explained. The color conversion plate 5 is produced according to the steps as shown in FIG. 4(a) to FIG. 4(c). A substrate is prepared, which is made of resin or glass where a predetermined concentration of green phosphor is dispersed in advance. By way of example, this substrate may be a molten glass molding plate, or an injection-molding plate using an epoxy resin, a silicone resin, or a composite resin thereof. As shown in FIG. 4(a), hemispherical concave portions 41 each having a predetermined diameter and arranged at a predetermined distance are molded by a transfer using a template on one surface of the green phosphor substrate. This plate forms the green phosphor region 21 (sea part).

Next, as shown in FIG. 4(b), the concave portions 41 are filled with a thermosetting resin 42 in which a predetermined concentration of the red phosphor is dispersed, by using a squeegee printing method or the like, and then the thermosetting resin is hardened. The resin being filled forms the red phosphor region 22 (island part).

Finally, as shown in FIG. 4(c), the substrate is cut into a size equivalent to or larger than the size of the light emitting element 3, by using a cutting blade 43 or the like, thereby producing the color conversion plate 5.

A semiconductor light emitting element 3 is mounted by flip-chip bonding method, on a substrate 1 prepared separately, by using Au bump 2. Thereupon, a transparent adhesive agent is coated to form a transparent adhesion layer 4, and the color conversion plate 5 produced by the steps above is mounted thereon, in such a manner that the surface where the red phosphor regions 22 are formed faces to the light emitting element 3 side.

Finally, a resin such as a thermosetting resin in which filler such as titanium oxide is dispersed, coats all over the side surfaces of the light emitting element 3 and the color conversion plate 5, by using a dispenser coating applicator or the like, and subsequently, it is hardened. According to the steps as described above, the light emitting device as shown in FIG. 1(a) and FIG. 1(b) is completed.

### Second Embodiment

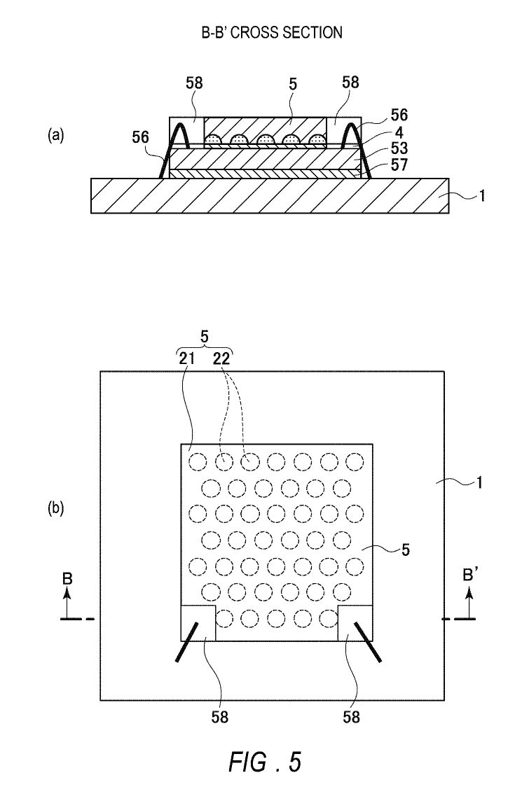

The light emitting device according to a second embodiment will be explained with reference to FIG. 5(a) and FIG. 5(b). In the light emitting device as shown in FIG. 5(a) and FIG. 5(b), a semiconductor light emitting element 53 which emits blue light is implemented on the substrate 1 where electrode and wiring are formed in advance, by using AuSn eutectic 57 and Au bonding wire 56. The color conversion plate 5 is bonded on the semiconductor light emitting element 53 via the transparent adhesion layer 4.

The semiconductor light emitting element 53 includes an element substrate and a light emitting layer formed thereupon. The semiconductor light emitting element 53 is a metal bonding (Metal Bonding: MB) element, therefore the element substrate is opaque to blue light. Hereinafter, in the second embodiment, the semiconductor light emitting element 53 is referred to as MB element 53. The MB element 53 is bonded to the substrate 1 by die bonding via AuSn eutectic 57, allowing the element substrate to face the substrate 1 and the light emitting layer to face the color conversion plate 5. An Au wire pad, not illustrated, is formed on the upper surface of the MB element 53, and it is connected to the electrode on the substrate 1 via the bonding wire 56.

Structures of the regions 21 and 22 of the color conversion plate 5 are the same as those in the first embodiment, but it is necessary that the regions 21 and 22 have to be arranged in such a manner as avoiding the area where the bonding wire 56 is bonded on the upper surface of the MB element 53. Therefore, in the second embodiment as shown in FIG. 5(a) and FIG. 5(b), a notch 58 is provided on the edge of the color conversion plate 5.

A method for producing the color conversion plate 5 according to the second embodiment is the same as the production method of the first embodiment as shown in FIG. 4(a) to FIG. 4(c). However, in the second embodiment, when the green phosphor dispersed plate is subjected to die machining in the step of FIG. 4(a), the notch 58 is formed as a hole which corresponds to a shape of the Au wire pad on the light element 3 surface. It is to be noted that on a large-area plate, a hole portion is formed, which is commonly used for combined notches 58 of adjacent color conversion plates 5, thereby facilitating the process. A process for partitioning can be performed with a high degree of precision, thereby enabling mass production.

When the red phosphor region 22 being an island part is formed in the step of FIG. 4(b), the squeegee printing method or a dispenser coating method may be applied as in the case with the first embodiment. However, since a hole portion serving as the notch 58 is formed, it is preferable that masking is applied to the notch 58 with a film or a tape when the printing method is conducted. When the dispenser coating method is employed, it is applicable by producing programs, according to which a drop position from the dispenser device avoids the location of the notch 58.

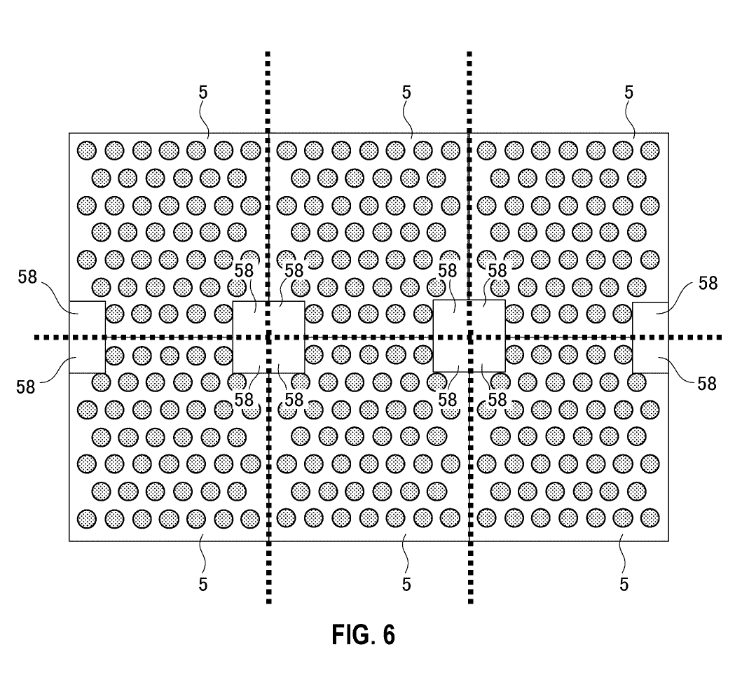

In the step of FIG. 4(c), the large-area plate is cut out by the cutting blade in such a manner as shown in FIG. 6, thereby producing the color conversion plate with the notch 58 being formed.

An operation and effect of the color conversion in the light emitting device according to the second embodiment are the same as those of the first embodiment.

As described in the second embodiment, the color conversion plate 5 of the present invention is applicable to the light emitting device which employs the MB element 53.

### Third Embodiment

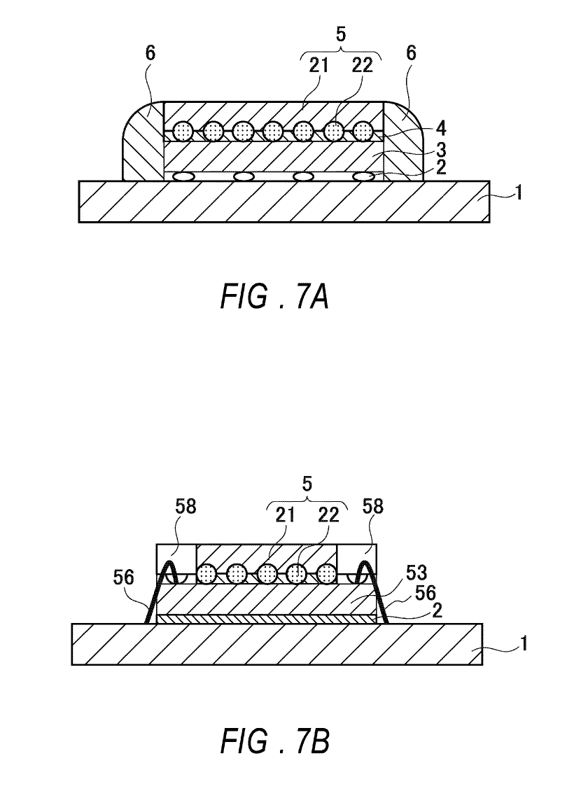

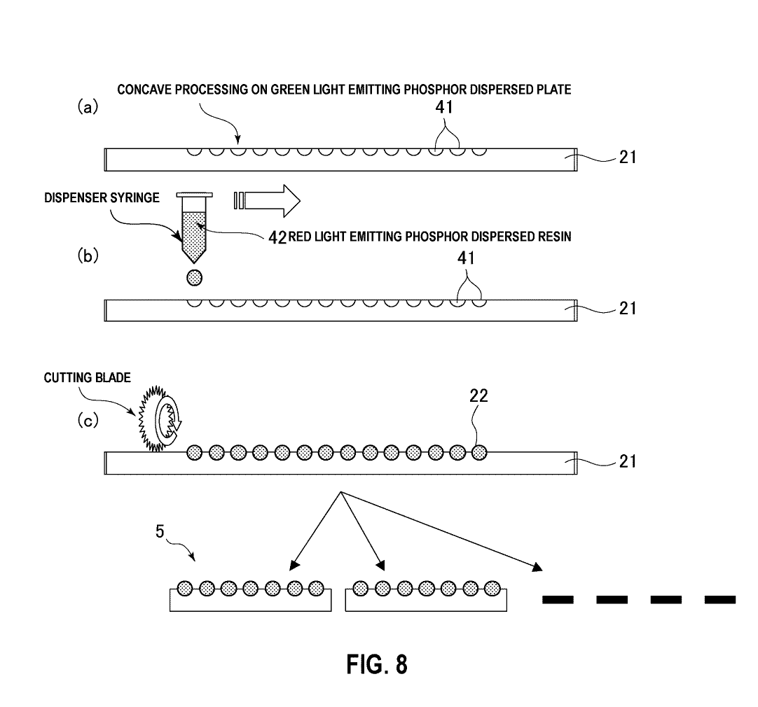

Next, the light emitting device according to a third embodiment will be explained with reference to FIG. 7A and FIG. 8. The light emitting device according to the third embodiment has the same configuration as the light emitting device of the first embodiment, except the configuration of the color conversion plate. As shown in FIG. 7A which illustrates a sectional view of the device, the light emitting device according to the third embodiment includes the red phosphor region 22 being the island part which has a spherical shape, and a half of the sphere protrudes from the lower surface of the plate-like green phosphor region 21.

In the color conversion plate 5 as described above, a half of the red phosphor region 22 being the island part protrudes toward the light emitting element 3 side, and therefore, the tip of the protruding hemispherical part comes into contact with the upper surface of the light emitting element 3 like a dot. A light substance outputted at a certain angle with respect to the horizontal plane, out of the blue light outputted from the light emitting element 3, enters the surface of the protruding hemispherical part of the red phosphor region 22 being the island part, at approximately right angle. Therefore, the blue light is allowed to enter the protruding hemispherical red phosphor region 22 with a high degree of efficiency. The amount of the blue light entering the red phosphor region 22 is increased, thereby enhancing the excitation efficiency of the red phosphor.

Accordingly, the red light emitting substance becomes larger in quantity, relative to the first embodiment. Considering the situation above, the size, shape, and the phosphor concentration of the red phosphor region 22 being the island part may be adjusted, thereby enabling a control of mixed color balance among the red, green, and blue light.

Preferably, the transparent adhesion layer 4 is formed with a thickness equivalent to the height of the protrusion of the red phosphor region 22. In this structure, the red phosphor region 22 protrudes, and therefore the contact area between the transparent adhesion layer 4 and the color conversion plate 5 is larger relative to that of FIG. 1(a) and FIG. 1(b). Accordingly, the adhesion force is improved between the light emitting element 3 and the color conversion plate 5.

When an elastic material such as silicone resin is used as a resin for the red phosphor region 22, the red phosphor regions 22 being the island parts may serve as a multipoint stress absorber, and even when external stress and thermal stress are applied, separation of the adhesion layer 4 is hard to occur, and an effect is produced such as suppressing deterioration of brightness and enhancing the reliability.

With reference to FIG. 8, steps for producing the color conversion plate 5 according to the third embodiment will be explained. A step for forming the green phosphor region 21 provided with the concave portions as shown in FIG. 8(a) is the same as the step of the first embodiment as shown in FIG. 4(a). In the third embodiment, in order to form the red phosphor region 22, red phosphor dispersed resin is dropped into the concave portion 41 by using a dispenser or the like in the step of FIG. 8(b). The resin is heaped up on the concave portion 41 according to surface tension, and while holding this status, the resin is hardened. By adjusting viscosity and the drop amount of the red phosphor dispersed resin, it is possible to form the red phosphor region 22 having an approximately spherical shape. Finally, the large-area plate is cut into individual color conversion plates by using the cutting blade, and the color conversion plate 5 of the third embodiment is completed. Steps other than the step for producing the color conversion plate 5 are conducted in the same manner as the first embodiment, and accordingly, the light emitting device of the third embodiment can be produced.

It is to be noted that in the present embodiment, there has been explained the case where the red phosphor region 22 has a spherical shape. However, the shape is not limited to such spherical shape, and it is sufficient as long as there is a minimal part of the red phosphor region 22 which protrudes from the lower surface of the color conversion plate 5. With this configuration, it is possible to produce an effect that the amount of blue light is increased which enters the red phosphor region 22.

Furthermore, even in the case employing the MB element 53, as shown in FIG. 7B, the light emitting device can be configured in the same manner by using the color conversion plate 5 of the third embodiment. For this case, the notch 58 is provided on the color conversion plate 5, in the same way as the color conversion plate of the second embodiment as described above.

### Fourth Embodiment

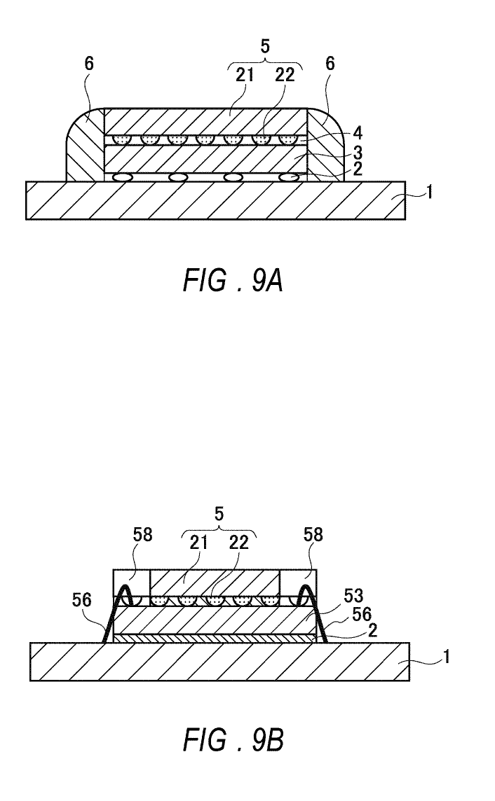

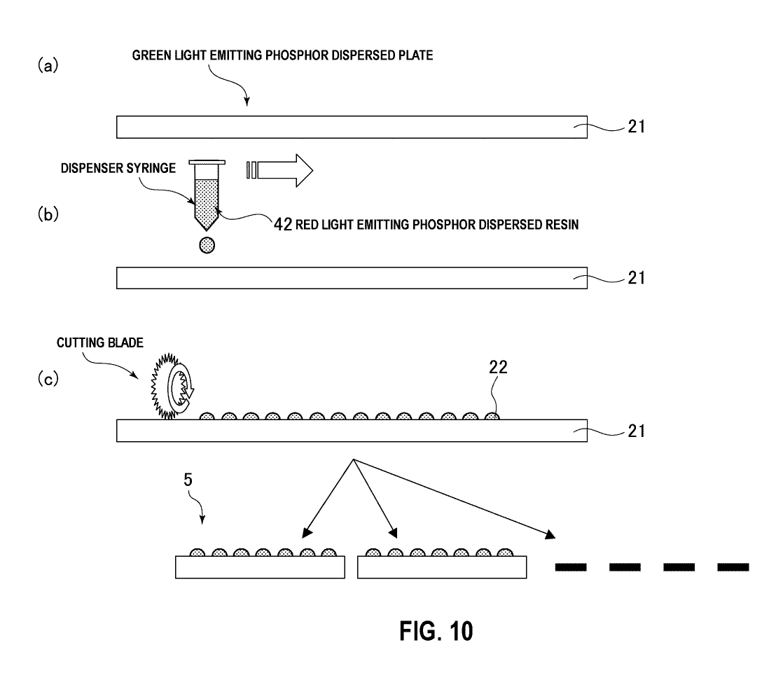

The light emitting device according to a fourth embodiment will be explained with reference to FIG. 9A and FIG. 10. In the light emitting device of the fourth embodiment, as shown in FIG. 9A illustrating the cross section thereof, the green phosphor region 21 being the sea part has a flat plate shape without any concave portions, and the red phosphor region 22 being the island part protrudes from the lower surface of the flat plate-like green phosphor region 21 in a hemispherical shape. The configuration except the element above is the same as the light emitting device of the third embodiment.

In the same way as the third embodiment, in the light emitting device of the fourth embodiment, the red phosphor region 22 being the island part protrudes from the lower surface of the green phosphor region 21 in a hemispherical shape, thereby allowing highly efficient entering of light substances outputted at an angle with respect to the horizontal plane, out of the blue light outputted from the light emitting element 3. Accordingly, the light amount of the blue light entering the red phosphor region 22 is increased, thereby enhancing the excitation efficiency of the red phosphor.

Furthermore, the plate-like green phosphor region 21 is structured without any concave portions, the interface between the red phosphor region 22 and the green phosphor region 21 has a circular shape. Therefore, compared to the device according to the first to the third embodiments in which the shape of the interface is a hemisphere, the area of the interface (contact area) becomes ½ (area of the circle/surface area of the hemisphere=πr²/2πr²=½). As thus described, since the contact area between the red phosphor region 22 and the green phosphor area 21 is reduced, the absorption of the green fluorescence emitted from the green phosphor region 21 by the red phosphor region 22 is further suppressed, than the device according to the first to the third embodiments. Consequently, the overall excitation efficiency of the color conversion plate can be enhanced.

Furthermore, similar to the third embodiment, the contact area between the transparent adhesion layer 4 and the color conversion plate 5 is increased, and an effect is produced that an adhesion force is improved.

When an elastic material such as silicone resin is employed as the resin to be used for the red phosphor region 22, separation of the adhesion layer 4 hardly occurs, and an effect can be produced such as suppressing the deterioration of brightness and enhancing the reliability.

As explained in the following, since it is not necessary for the device according to the fourth embodiment to form a concave portion on the plate-like green phosphor region 21, a production cost can be reduced.

With reference to FIG. 10, steps for producing the color conversion plate 5 according to the fourth embodiment will be explained. As shown in FIG. 10(a), a plate-like substrate made of resin or glass in which a predetermined concentration of the green phosphor is dispersed in advance is prepared as the green phosphor region 21. No concave portions are formed.

Next, in the step of FIG. 10(b), in order to form the red phosphor region 22, a red phosphor dispersed resin 42 is dropped at a predetermined distance on one surface of the plate-like green phosphor region 21, the resin is heaped up in the shape of hemisphere according to the surface tension, and while holding this status, the resin is hardened. By adjusting viscosity and the drop amount of the red phosphor dispersed resin, it is possible to form a plate having a cross-section where the red phosphor regions 22 each having an approximately hemispherical shape with a desired size are arranged at a predetermined distance.

Finally, as shown in FIG. 10(c), the large-area plate is cut into individual color conversion plates by means of the cutting blade, and the color conversion plate 5 of the fourth embodiment is completed. Steps other than the step for producing the color conversion plate 5 are conducted in the same manner as the first embodiment, and accordingly, the light emitting device of the fourth embodiment can be produced.

It is to be noted that in the fourth embodiment, there has been explained the case where the red phosphor region 22 has a hemispherical shape. However, the shape is not limited to such hemispherical shape, and a desired shape can be formed by adjusting the viscosity and the drop amount of the red phosphor dispersed resin.

Furthermore, even in the case where the MB element 53 is employed, as shown in FIG. 9B, the light emitting device can be configured in the same manner, using the color conversion plate 5 of the fourth embodiment. For this case, the color conversion plate 5 is provided with the notch 58, in the same way as the color conversion plate of the second embodiment as described above.

### Fifth Embodiment

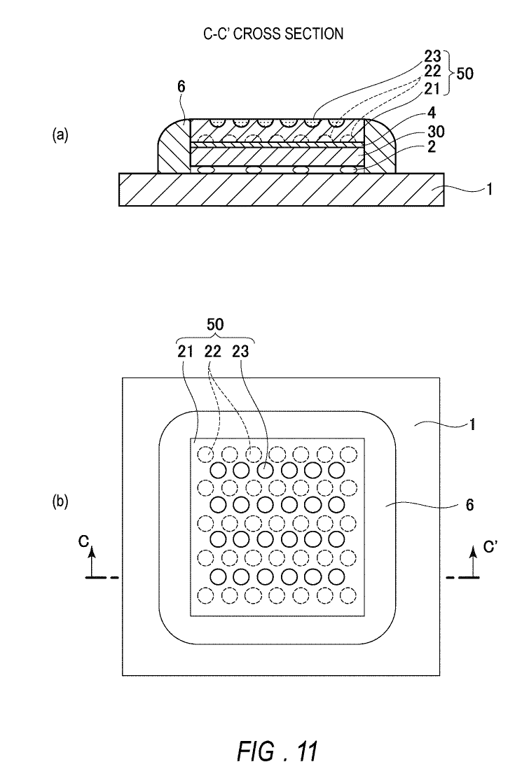

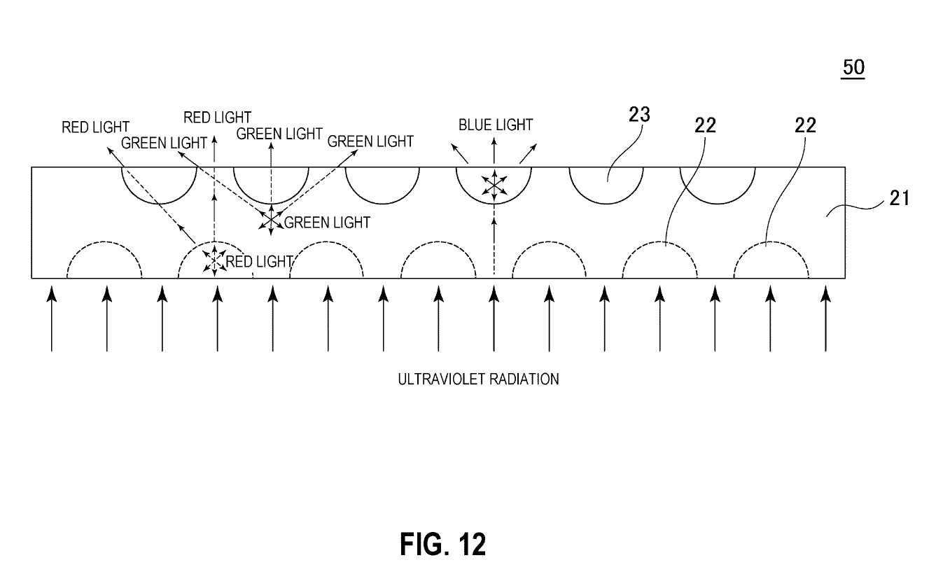

Next, a fifth embodiment of the present invention will be explained with reference to FIGS. 11(a) and (b), and FIG. 12. Unlike the first to the fourth embodiments, the light emitting device according to the fifth embodiment employs alight emitting element which emits ultraviolet radiation, and converts the ultraviolet radiation into the red light, green light, and blue light, so that white light obtained by mixing those blue, red, and green light is emitted.

FIG. 11(a) and FIG. 11(b) illustrate a cross sectional view and a top view of the light emitting device according to the fifth embodiment. The light emitting device of FIG. 11(a) and FIG. 11(b) includes the light emitting element 30 which emits ultraviolet radiation, and the structure of the color conversion plate 50 is different from the color conversion plate 5 as shown in FIG. 1(a) and FIG. 1(b). The transparent adhesion layer 4 is transparent to the ultraviolet radiation, and the red, green, and blue light. The other structure is the same as the device as shown in FIG. 1 (a) and FIG. 1(b).

As shown in the enlarged view of FIG. 12, the color conversion plate 50 is similar to the color conversion plate 5 of the first embodiment, in the point that a hemispherical red phosphor region is scattered in the form of island with a predetermined space between the regions, on the lower surface of the plate-like green phosphor region 21 (the surface on the light emitting element 30 side). Additionally, in the present embodiment, a hemispherical blue phosphor region 23 is scattered in the form of island with a predetermined space between the regions on the upper surface of the green phosphor region 21.

The blue phosphor region 23 is arranged at the position being offset so as not to overlap the red phosphor region 22, when viewing the color conversion plate 50 from the upper surface in the two-dimensional array.

For example, CaAlSiN₃:Eu, (Ca,Sr)₂Si₅N₈:Eu, or (Ca,Sr)S:Eu which absorbs ultraviolet radiation and emits red fluorescence may be employed as the red phosphor of the red phosphor region 22. For example, (Ba,Sr)₂SiO₄:Eu, CaSc₂O₄:Ce, (Ca,Sr)Ga₂S₄:Eu, Ca₈MgSi₄O₁₆Cl₂:Eu, or (Si,Al)₆(O,N)₈:Eu which absorbs ultraviolet radiation and emits green fluorescence may be employed as the green phosphor of the green phosphor region 21. For example, BaMgAl₁₀O₁₇:Eu, (Sr,Ca,Ba,Mg)₁₀(PO₄)₆Cl₂:Eu, or Sr₁₀(PO₄)₆Cl₂:Eu which absorbs ultraviolet radiation and emits blue fluorescence may be employed as the blue phosphor of the blue phosphor region 23. Preferably, a material used as a base of the red phosphor region 22 and the blue phosphor region 23 may be transparent to the ultraviolet radiation, red, green, and blue light, and this material can be molded by a printing method. For example, a silicone resin being a thermosetting resin, an inorganic binder in which low-fusing point glass powder is dispersed, or the like, may be employed. Preferably, a material used as a base for dispersing the green phosphor of the green phosphor region 21 may be transparent to the ultraviolet radiation, red, green, and blue light, and this material is processible into a predetermined shape by an injection molding and metal molding, for instance. For example, a silicone resin, a composite resin thereof, or glass may be employed.

In the light emitting device according to the present embodiment, ultraviolet radiation outputted from the light emitting element 30 transmits the transparent adhesion layer 4, and enters the lower surface (the surface on the light emitting element 30 side) of the color conversion plate 50. As shown in FIG. 12, it is configured such that the red phosphor region 22 is scattered like an island on the lower surface of the color conversion plate 50, and the green phosphor region 21 like the sea spreads between the islands. Therefore, the ultraviolet radiation directly enters both the red phosphor region 22 and the green phosphor region 21, and excites the respective phosphors. Accordingly, the red phosphor region 22 emits the red fluorescence. The green phosphor region 21 emits the green fluorescence.

Red fluorescence generated in the island-like red phosphor region 22 of the color conversion plate 50 passes through the interface with the green phosphor region 21, and enters the green phosphor region 21. Then, the red fluorescence passes through the green phosphor region 21, and further depending on the passing route, the red fluorescence also may pass through the blue phosphor region 23, and it is outputted from the upper surface of the color conversion plate 50. On this occasion, both an absorption edge of the green phosphor absorption spectrum and an absorption edge of the blue phosphor spectrum are located on the shorter wavelength side than the red light wavelength range. Therefore, the red fluorescence is allowed to pass through without being absorbed by the green phosphor region 21 and the blue phosphor region 23, and the intensity of the red fluorescence is not attenuated.

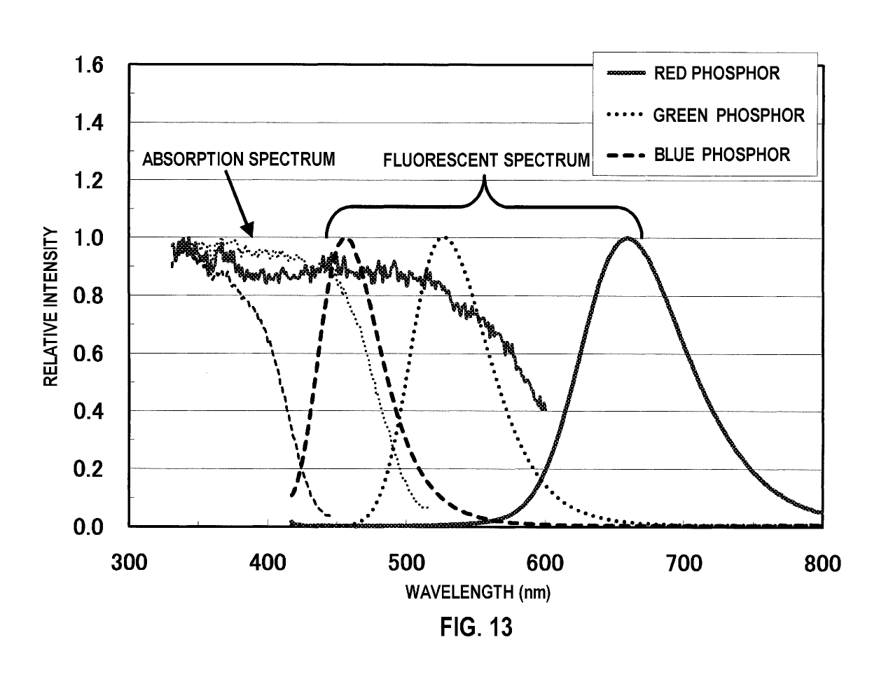

On the other hand, a part of the green fluorescence, which is directed to the upper side, out of the green fluorescence generated in the green phosphor region 21 being the sea part is directly outputted from the upper surface, or outputted after passing through the blue phosphor region 23 depending on the optical path. As shown in FIG. 13, the absorption edge of the blue phosphor absorption spectrum is located on the shorter wavelength side than the green light wavelength range. Therefore, the green fluorescence is allowed to pass through without being absorbed by the blue phosphor region 23, and allowed to be outputted without attenuating the intensity of the green fluorescence. In addition, since the red phosphor region 22 is located at the lower surface side, most of the green fluorescence directed to the upper side does not pass through the red phosphor region 22, enabling reduction of the attenuation caused by the red phosphor region 22 which absorbs the green light.

The ultraviolet radiation which has passed through only the green phosphor region 21 and the ultraviolet radiation which has passed through the red phosphor region 22 and the green phosphor region 21 enter the blue phosphor region 23, thereby exciting the blue phosphor. Accordingly, the blue fluorescence is emitted, and such emitted blue light is directly outputted from the upper surface of the blue phosphor region 23. Therefore, the blue light can be outputted without any attenuation.

Consequently, white light which is obtained by mixing the red light, green light, and blue light is outputted from the upper surface of the color conversion plate 5.

In the fifth embodiment, the blue phosphor region 23 has a hemispherical shape. Therefore, the area of the interface between the blue phosphor region and the green phosphor region 21 becomes smaller than the interface area in the structure where the blue phosphor region and the green phosphor region are laminated. Therefore, it is possible to suppress the phenomenon that the blue fluorescence is absorbed by the green phosphor region 21.

The blue phosphor region 23 is arranged at the position being offset so as not to overlap the red phosphor region 22, when viewed in the two-dimensional array from the upper surface. Therefore, the ultraviolet radiation is allowed to pass through only the green phosphor region 21, and reach the blue phosphor region 23. Accordingly, compared to the conventional technique where the red phosphor region, the green phosphor region, and the blue phosphor region are laminated in the form of layers, the number of interfaces to pass through to reach the blue phosphor region 23 is small, suppressing the attenuation of the ultraviolet radiation, thereby allowing a large optical amount of ultraviolet radiation to enter the blue phosphor region 23.

Since the blue phosphor region 23 has a hemispherical shape, there is another advantage that the ultraviolet radiation which enters at a slant with respect to the principal plane is allowed to enter the blue phosphor region 23 with a high degree of efficiency.

As thus described above, in the color conversion plate 50 of the present embodiment, the blue phosphor region 23 is arranged on the upper surface side. Therefore, the island-like red phosphor region 22 and the sea-like green phosphor region 21 are exposed on the lower surface side of the color conversion plate, and the ultraviolet radiation emitted from the light emitting element 30 is allowed to directly enter the green phosphor region 21 and the red phosphor region 22, respectively. Therefore, it becomes possible that the green phosphor region 21 and the red phosphor region 22 are excited within an identical incident plane, thereby maximizing the excitation efficiency of both phosphors.

With the arrangement as described above, the red fluorescence has to pass through the green phosphor region 21 and the blue phosphor region 23 in order to be outputted from the upper surface. However, since the red light is not absorbed by the green phosphor and the blue phosphor as described above, the red light can be efficiently extracted from the upper surface toward the outside.

On the other hand, since the red phosphor region 22 has a hemispherical shape, the interface area between the red phosphor region and the green phosphor region 21 is smaller than the laminated structure, as explained in the first embodiment, and the green fluorescence generated in the green phosphor region is absorbed little by the red phosphor region 22. Furthermore, since the blue phosphor 23 being the island part, scattered on the light retrieving side, does not absorb the green light, it is possible to output the green light from the upper surface with a high degree of efficiency.

In the light emitting device according to the present embodiment, the amount of phosphor being contained and the hemispherical region size of the red phosphor region 22 and the blue phosphor region 23 of the color conversion plate 50 may be adjusted, respectively, thereby controlling the intensity of the red light and the blue light. If the hemispherical region size is adjusted, the light amount of the ultraviolet radiation entering the green phosphor region 21 is changed, and therefore the amount of the green phosphor is also changed. In addition, the amount of the green phosphor of the green phosphor region 21 and the thickness of the plate 5 may be adjusted, thereby changing the light amount of the green phosphor. Consequently, with such adjustments as described above, there is also an effect that chromaticity and brightness of the white light can be changed to desired values.

In the similar manner as the first embodiment, the color conversion plate 50 of the fifth embodiment can be obtained by a large-area production which uses a general printing method. Therefore, even though it is divided into an element size, an individual plate 50 has a uniform color conversion function within an identical lot. Compared to a conventional technique in which three layers of red, green, and blue phosphors are laminated, it is possible to considerably enhance yields of the product with less variation in color.

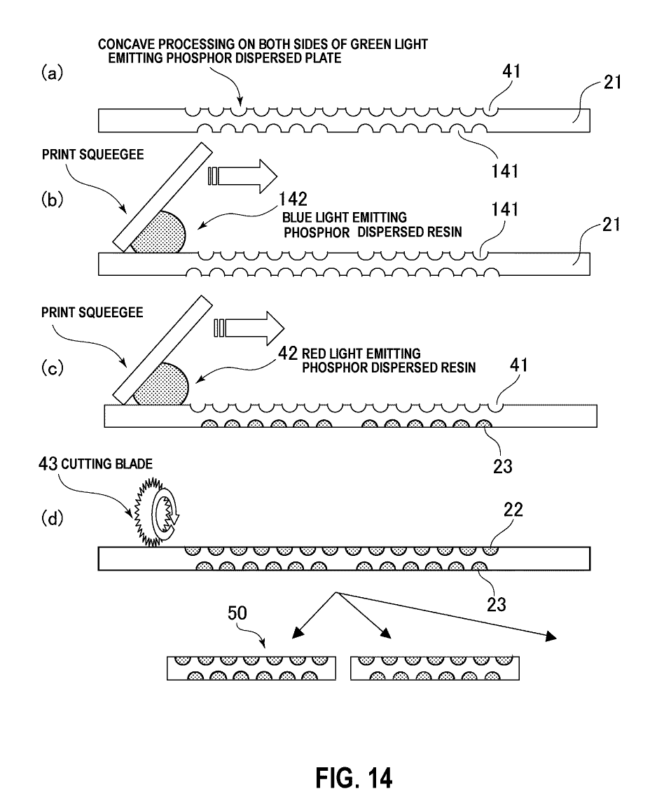

Hereinafter, a method for producing the color conversion plate 50 according to the fifth embodiment will be explained with reference to FIG. 14(a) to FIG. 14(d).

A substrate is prepared, which is made of resin or glass where a predetermined concentration of green phosphor is dispersed in advance. As shown in FIG. 14(a), hemispherical concave portions 41 and 141 having a predetermined diameter and spacing therebetween are molded by a transfer on both sides of the green phosphor substrate by using a template. This plate forms the green phosphor region 21 (sea part).

Next, as shown in FIG. 14(b), the concave portions 141 are filled with a thermosetting resin 142 in which a predetermined concentration of the blue phosphor is dispersed, by using the squeegee printing method or the like, and then the thermosetting resin is hardened. The resin being filled forms the blue phosphor region 23 (island part).

Next, as shown in FIG. 14(c), the green phosphor substrate is turned upside down, and the concave portions 41 are filled with a thermosetting resin 42 in which a predetermined concentration of the red phosphor is dispersed, by using the squeegee printing method or the like, and then the thermosetting resin is hardened. The resin being filled forms the red phosphor region 22 (island part).

Finally, as shown in FIG. 14(d), the substrate is cut into a size equivalent to or larger than the size of the light emitting element 3, by using the cutting teeth 43 or the like, thereby producing the color conversion plate 50.

A semiconductor light emitting element 30 for emitting ultraviolet radiation is mounted by flip-chip bonding method on the substrate 1 which is prepared separately, by using Au bump 2. The transparent adhesion layer 4 is formed thereon, and then the color conversion plate 50 is mounted. Finally, a resin such as a thermosetting resin, in which a filler such as titanium oxide is dispersed, coats all over the side surfaces of the light emitting element 30 and the color conversion plate 50, by using a dispenser coating applicator or the like, and subsequently, it is hardened. According to the steps as described above, the light emitting device as shown in FIG. 11(a) and FIG. 11(b) is completed.

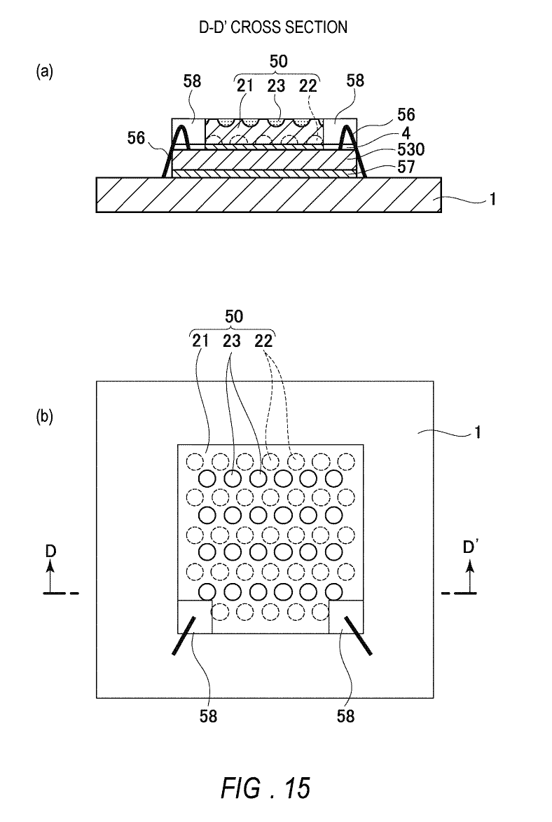

It is to be noted that the light emitting device as shown in FIG. 11(a) and FIG. 11(b) employs the flip-chip type light emitting element 30. However, the color conversion plate 50 of the fifth embodiment may be applicable in the case where the light emitting element is the MB element 530 as shown in FIG. 15(a) and FIG. 15(b). For this case, as explained in the second embodiment, a notch 58 having the shape corresponding to the shape of Au wire pad on the surface of the MB element 530 is formed on the color conversion plate 50 as shown in FIG. 15(b). Since the configuration other than those described above is the same as the configuration of the second embodiment, tedious explanations will not be made.

### Sixth Embodiment

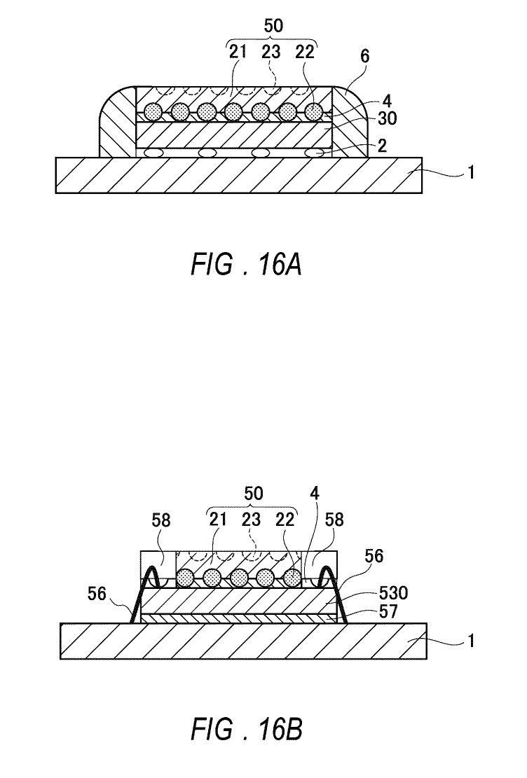

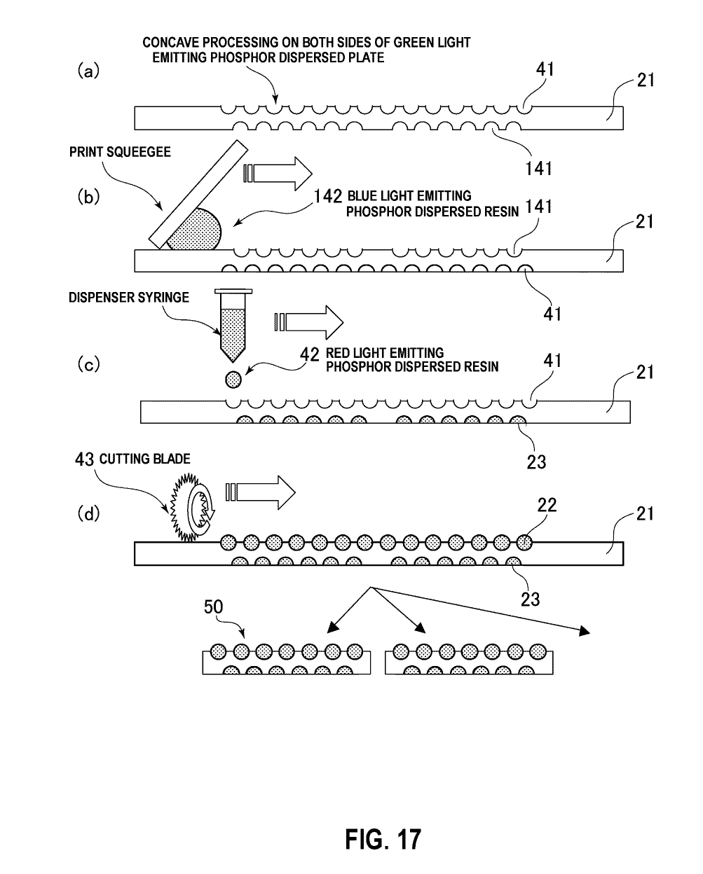

Next, with reference to FIG. 16A and FIG. 17(a) to FIG. 17(d), the light emitting device according to a sixth embodiment will be explained. In the light emitting device of the sixth embodiment, the red phosphor region 22 of the color conversion plate 50 in the light emitting device of the fifth embodiment is formed to be a spherical shape, and a half of the sphere protrudes from the lower surface of the plate-like green phosphor region 21.

Since a half of the red phosphor region 22 being the island part, protrudes toward the light emitting element 3 side, in the same manner as the color conversion plate 5 of the third embodiment, the light amount of the ultraviolet radiation entering the red phosphor region 22 is increased, thereby enhancing the excitation efficiency of the red phosphor.

The contact area between the transparent adhesion layer 4 and the color conversion plate 50 is larger than that of the structure as shown in FIG. 11(a) and FIG. 11(b), and there is an effect that the adhesion force between the light emitting element 3 and the color conversion plate 50 is improved.

In addition, when an elastic material such as silicone resin is employed as the resin to be used for the red phosphor region 22, separation of the adhesion layer 4 hardly occurs, and an effect can be produced such as suppressing decrease of brightness and enhancing the reliability.

With reference to FIG. 17(a) to FIG. 17(d), steps for producing the color conversion plate 50 of the sixth embodiment will be explained.

According to the steps as shown in FIG. 17(a) and FIG. 17(b), after the concave portions 41 and 141 are formed on both sides of the green phosphor plate, the concave portion 141 is filled with the blue phosphor dispersed resin 142 by a printing method, thereby forming the blue phosphor region 23. Those steps above are same as those of the fifth embodiment as shown in FIG. 14(a) and FIG. 14(b).

Next, in the step as shown in FIG. 17(c), the red phosphor dispersed resin 42 is dropped in the concave portion 41 by a disperser or the like, and the resin is heaped up in the concave portion 41 according to the surface tension, and while holding this status, the resin is hardened. Accordingly, it is possible to form the red phosphor region 22, which has an approximately spherical shape.

Finally, as shown in FIG. 17(d), the large-area plate is cut into individual color conversion plates, by using the cutting blade, thereby producing the color conversion plate 50 of the sixth embodiment.

It is to be noted that the red phosphor region 22 is not limited to such spherical shape, and it is sufficient as long as there is a minimal part of the red phosphor region 22 protruding from the lower surface of the color conversion plate 50. With this configuration, it is possible to produce an effect that the amount of ultraviolet radiation is increased which enters the red phosphor region 22.

Also in the case where the light emitting element is the MB element 530, it is possible to configure the light emitting device in the same manner as described above, by using the color conversion plate 50 of the sixth embodiment shown in FIG. 16B. A notch 58 is provided on the color conversion plate 50, as explained in the second embodiment.

### Seventh Embodiment

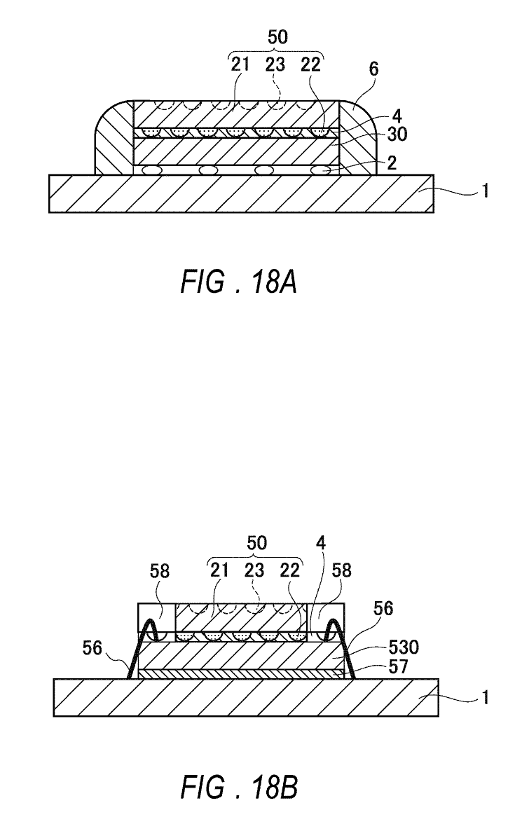

With reference to FIG. 18A, the light emitting device according to a seventh embodiment will be explained. As illustrated by the cross section shown in FIG. 18A, in the light emitting device of the seventh embodiment, a concave portion is not provided on the lower surface of the green phosphor region 21 being the sea part, and the red phosphor region 22 being the island part protrudes in the shape of hemisphere, from the lower surface of the plate-like green phosphor region 21. The other configuration such as the blue phosphor region 23 on the upper surface is the same as the configuration of the light emitting device according to the fifth embodiment.

In the present embodiment, since the lower surface of the green phosphor region 21 has a flat surface, the interface between the red phosphor region 22 and the green phosphor region 21 has a circular shape, and as described in the fourth embodiment, the area of the interface (contact area) becomes half relative to the device of the fifth embodiment in which the interface has a hemispherical shape. Accordingly, it is possible to suppress more absorption by the red phosphor region 22, of the green fluorescence emitted by the green phosphor region 21, relative to the case of the fifth embodiment.

Furthermore, similar to the sixth embodiment, an effect is produced that the adhesion force between the light emitting element 30 and the color conversion plate 50 is improved.

In addition, when an elastic material such as silicone resin is employed as the resin to be used for the red phosphor region 22, separation of the adhesion layer 4 hardly occurs, and an effect can be produced such as suppressing decrease of brightness and enhancing the reliability.

In the steps for producing the color conversion plate 50 according to the present embodiment, the concave portion 41 is not formed, unlike the step of the sixth embodiment as shown in FIG. 17(a). The other steps are the same as those shown in FIG. 17(b) to FIG. 17(d).

Also in the case where the light emitting element is the MB element 530, it is possible to configure the light emitting device in the same manner as described above, by using the color conversion plate 50 of the seventh embodiment as shown in FIG. 18B. A notch 58 is provided on the color conversion plate 50, as explained in the second embodiment.

In the aforementioned fifth to the seventh embodiments, it is explained that the color conversion plate 50, as an example, applies wavelength conversion to the ultraviolet radiation, into red, green, and blue light, which are the light's three primary colors, by using the red phosphor, the green phosphor, and the blue phosphor. However, a combination of colors obtained by the wavelength conversion is not limited to the combination above. By way of example, three types phosphors; violet phosphor (V), blue-green phosphor (BG), and orange phosphor (OR) may be used for mixing colors of violet light, blue-green light, and orange light, so as to synthesize those colors into white light. For this case, those phosphors above are assumed as the first phosphor, the second phosphor, and the third phosphor, in the order from the one having longer light wavelength. Then, the first phosphor is dispersed in the island-like region on the surface on the light emitting element side of the color conversion plate 50, the second phosphor is dispersed in the sea region, and the third phosphor is dispersed in the island region on the upper surface.

In the aforementioned fifth to the seventh embodiments, one color conversion plate 50 is divided into three regions, the green phosphor region 21, the red phosphor region 22, and the blue phosphor region 23, and then, the ultraviolet radiation is converted into the white light. However, the present invention is not limited to the division into three regions. By way of example, in the color conversion plate 5 having the structure as shown in FIG. 1(a) and FIG. 1(b), the green phosphor and the blue phosphor may be dispersed in the green phosphor region 21, thereby enabling the conversion from the ultraviolet radiation into the white light by using the red phosphor region 22 and the green-blue phosphor region 21.

Effects of the aforementioned first to seventh embodiments will be summarized as the following: (1) A red phosphor region is arranged as the island part and a green phosphor region is arranged as the sea part on the surface (lower surface) of the color conversion plate 5, 50 on the light emitting element side, and this configuration allows the light from the light emitting element to enter into the both regions simultaneously, thereby enhancing the excitation efficiency of each of the phosphors.

(2) The red phosphor region 22 is formed to have an island structure and the contact area with the green phosphor region 21 becomes smaller, and it is possible to suppress largely the absorption of the green fluorescence by the red phosphor 22 and efficiency in the wavelength conversion is enhanced.

(3) In the fifth to seventh embodiment, the blue phosphor region 23 is formed to have an island structure, thereby reducing the contact area with the green phosphor region 21, and it is possible to suppress largely the absorption of the blue fluorescence by the green phosphor 21 and efficiency in the wavelength conversion is enhanced.

(4) Each of the red phosphor region 22 and the blue phosphor region 23 has an island structure. Therefore, the green fluorescence of the green phosphor region 21 is allowed to be outputted directly to the outside without passing through these regions, and outward light extraction efficiency is enhanced.

(5) As in the case of the first and the fifth embodiments, the red phosphor region 22 being the island part is rendered to be a hemispherical shape, being convex upwardly with respect to the principal plane. Accordingly, the interface between the island part and the sea part forms a hemispherical shape, and the red fluorescence generated in the island part enters the interface at almost a right angle, thereby enhancing the efficiency of incidence into the sea part.

(6) As in the case of the third and the sixth embodiments, the red phosphor region 22 being the island part of the sea-island structure is made to form a spherical shape, half of which protruding from the lower surface of the color conversion plate 5. With this configuration, the efficiency of incidence from the semiconductor light emitting element 3, 30 to the red phosphor region 22, and the efficiency of incidence from the red phosphor region 22 to the green phosphor region 21 being the sea part are enhanced.

(7) As in the case of the fourth and the seventh embodiments, the red phosphor region 22 being the island part of the sea-island structure is made to form a convex hemispherical shape directed to down side with respect to the principal plane. Accordingly, the efficiency of incidence from the semiconductor light emitting element 3, 30 to the red phosphor region 22 is enhanced, and the absorption of the green fluorescence by the red phosphor region 22 is drastically suppressed.

### Eighth Embodiment

The light emitting device according to an eighth embodiment converts a part of blue light outputted from a blue-emission flip-chip element into red light and green light by a color conversion plate, and emits white light which is obtained by mixing the blue, red, and green light.

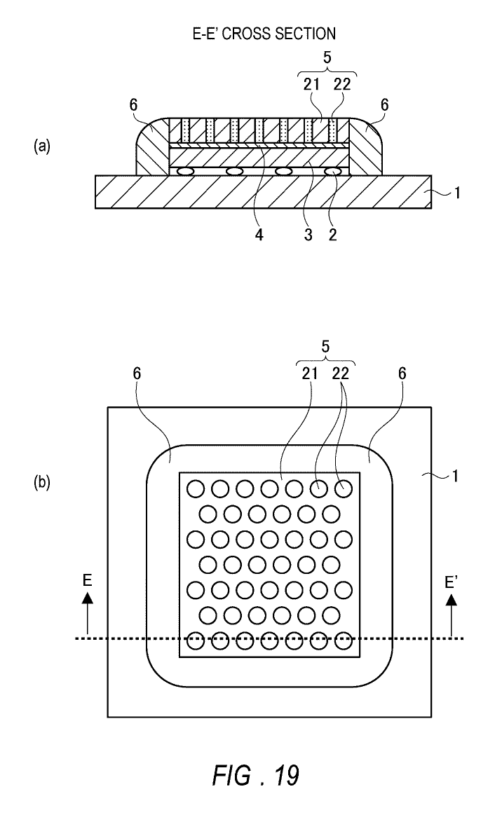

FIG. 19(a) illustrates a cross sectional view and FIG. 19(b) illustrates a top view of the light emitting device according to the eighth embodiment. In the light emitting device according to the present embodiment, the parts operating the same as those in the first to the seventh embodiment are labeled the same. As shown in FIG. 19(a), the flip-chip type semiconductor light emitting element 3 is implemented by using the Au bumps 2 on the substrate 1 on which electrode and wiring are formed in advance. On the semiconductor light emitting element 3, there is mounted a color conversion plate 5 via the transparent adhesion layer 4. The optical reflection frame 6 surrounds the side surfaces of the semiconductor light emitting element 3 and the color conversion plate 5.

The flip-chip type semiconductor light emitting element 3 includes, though not illustrated, an element substrate being transparent to the blue light, and a light emitting layer laminated thereon, and the light emitting layer is arranged on the substrate 1 side, and the element substrate is arranged facing to the color conversion plate 5 side.

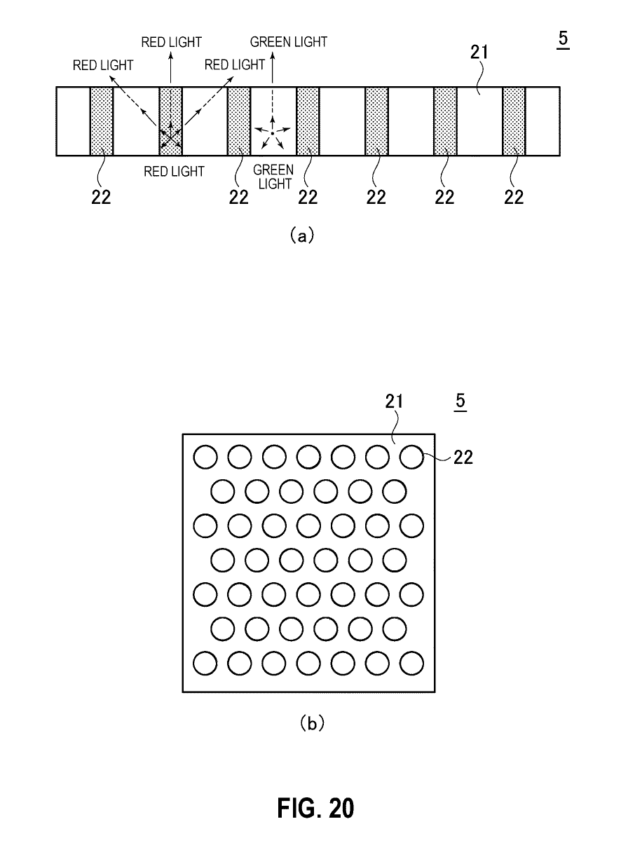

As shown in FIG. 20(a) and FIG. 20(b), which are an enlarged cross sectional view and an enlarged top view, the color conversion plate 5 includes a plate-like green phosphor region 21, and multiple cylindrically shaped red phosphor regions 22 provided in the thickness direction of this plate-like green phosphor region 21. These multiple cylindrically shaped regions are arranged two dimensionally in the principal plane direction.

In other words, the color conversion plate 5 is a plate having a sea-island structure in which the cylindrically shaped red phosphor regions 22 are scattered in the green phosphor region 21 (sea part).

The red phosphor and a base material of the red phosphor region 22, and the green phosphor and a base material of the green phosphor region 21 are the same as those used in the first embodiment. Materials for the transparent adhesion layer 4 and the optical reflection frame 6 are the same as those used in the first embodiment.

Homogeneity in chromaticity and brightness of the white light, which is emitted from the color conversion plate, is influenced by the diameter of the island-like red phosphor region 22. Therefore, the diameter of the cylinder of the red phosphor region 22 may be adjusted so that necessary chromatic homogeneity can be obtained. For example, when one side of the color conversion plate 5 is around 1 mm, it is desirable that the diameter of one of the red phosphor regions 22 is between or equal to around 20 μm and 200 μm, since this range may provide high chromatic homogeneity.

In the light emitting device according to the present embodiment as described above, the blue light outputted from the light emitting element 3 passes through the transparent adhesion layer 4, and enters the lower surface (the surface on the light emitting element 3 side) of the color conversion plate 5. As shown in FIG. 20(a), this device has a configuration that on the lower surface of the color conversion plate 5, the bottoms of the cylindrically shaped red phosphor regions 22 are exposed in a scattered manner, and the sea-like green phosphor region 21 spreads therebetween. Therefore, the blue light directly enters both the red phosphor regions 22 and the green phosphor region 21, thereby exciting the phosphors respectively. Accordingly, red fluorescence is emitted from the red phosphor region 22. Green fluorescence is emitted from the green phosphor region 21.

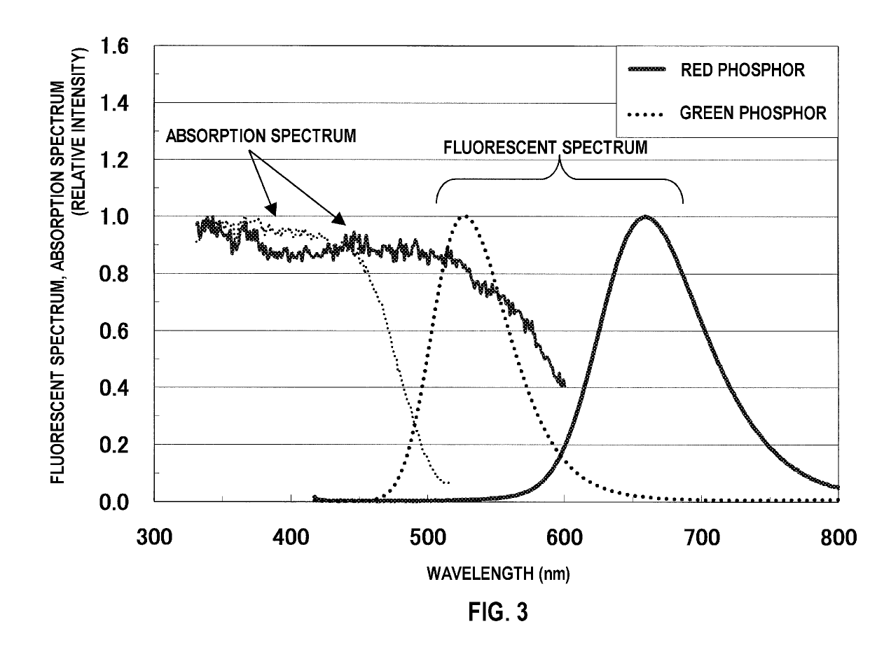

The red fluorescence generated in the cylindrically shaped red phosphor region 22 passes through the interface with the green phosphor region 21, enters and passes therethrough, and the red fluorescence is outputted from the upper surface of the color conversion plate 5. On this occasion, as shown in FIG. 3, since the absorption edge of the green phosphor absorption spectrum is located at a position on a shorter wavelength side than the red light wavelength range, the red fluorescence is allowed to pass through without being absorbed by the green phosphor region 21, and the intensity of the red phosphor is not attenuated.

On the other hand, a part of the green fluorescence, which is directed to the upper side, out of the green fluorescence generated in the green phosphor region 21, is directly outputted from the upper surface of the color conversion plate 5, without passing through the red phosphor region 22. Since the absorption edge of the absorption spectrum of the red phosphor partially overlaps the green light wavelength range, the red phosphor absorbs the green phosphor. However, in the present embodiment, the red phosphor exists only in the form of island having a cylindrical shape, and most of the green fluorescence generated in the sea-like green phosphor region 21 is allowed to reach the upper surface of the color conversion plate 5 without passing through the red phosphor region 22. Therefore, the absorption of the green fluorescence by the red phosphor may be limited to a little amount, thereby enabling an efficient output of the green fluorescence.

A part of the blue light which is outputted from the light emitting element 3 and enters the color conversion plate 5 transmits the red phosphor region 22 and the green phosphor region 21, then outputted from the upper surface of the color conversion plate 5.

Consequently, the white light obtained by mixing the red light, green light, and blue light is outputted from the upper surface of the color conversion plate 5.

Since the optical reflection frame 6 surrounds the side surfaces of the light emitting element 3 and the color conversion plate 5, it is possible to guide the light outputted from the side surface of the transparent substrate of the light emitting element 3 toward the color conversion plate 5. It is further possible to guide the light outputted from the side surface of the color conversion plate 5 in the upward direction. Accordingly, it is possible to enhance the color conversion efficiency and outputting efficiency of the color conversion plate.

As thus described, the color conversion plate 5 of the present embodiment has a structure that the green phosphor region 21 being the sea part and the red phosphor region 22 being the island part do not overlap one another in the optical path direction of the light emitting element 3 (a thickness direction of the color conversion plate 5). Therefore, the color conversion plate 5 is allowed to excite the red phosphor and the green phosphor with a high degree of efficiency.

In addition, the green phosphor region 21 is assumed as the sea part and the red phosphor region 22 is assumed as the island part, and the sea part surrounds the scattered island parts in the principal plane direction. Accordingly, the red light and the green light are mixed homogeneously, thereby emitting white light with little unevenness in chromaticity and brightness.

If the color conversion operation is explained along the optical path of the blue light emitted from the light emitting element 3 in practice, when the blue light passes through the green phosphor region 21 being the sea part, a part of the blue light is subjected to wavelength conversion by the green phosphor, and becomes blue-green light being mixed-color light. When the blue light passes through the red phosphor region 22 being the island part, a part of the blue light is subjected to wavelength conversion by the red phosphor, and becomes red-purple light being mixed-color light. Furthermore, the green light and the red light, respectively from the green phosphor region 21 being the sea part and the red phosphor region 22 being the island part, interfere with each other in the horizontal direction, thereby generating yellow light. As described above, an optic element is decomposed and synthesized, and therefore it is possible to obtain mixed white light extremely homogeneous, with a high degree of efficiency in wavelength conversion.

In the light emitting device of the present embodiment, the amount of phosphor contained in the red phosphor region 22 and the diameter of the cylinder may be adjusted, thereby controlling the intensity of the red light. By adjusting the diameter of the cylinder, the light amount of the blue light which enters the green phosphor region 21 is changed, and further, the amount of the green phosphor is also changed. Therefore, with such adjustments as described above, it is possible to change chromaticity and brightness of the white light to desired values.

The color conversion plate 5 of the present embodiment is obtained by using a general printing method, and one sheet of large-area plate is produced for a large number of pieces being continuous, and individual pieces are cut out, thereby enabling a production of a large number of pieces at one time. Therefore, a color conversion function of each color conversion plate 5 is uniform within an identical lot (an identical large-area plate), and it is possible to considerably enhance yields of the product with less variation in color, compared to a conventional art in which a color conversion material is coated and formed on an individual semiconductor light emitting element.

Hereinafter, one example of a method for producing the light emitting device according to the present embodiment will be explained.

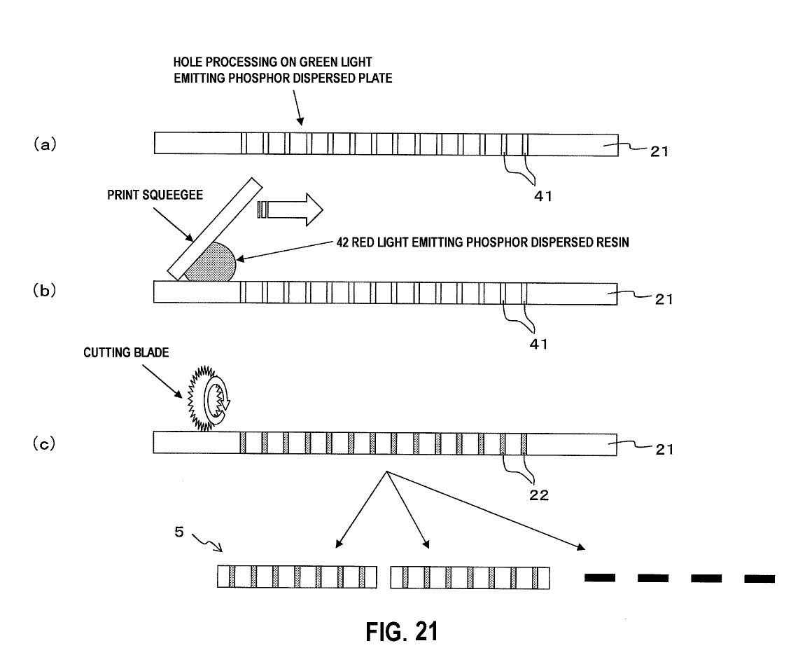

The color conversion plate 5 is produced according to the steps as shown in FIG. 21(a) to FIG. 21(c). A substrate is prepared, which is made of resin or glass where a predetermined concentration of green phosphor is dispersed in advance. By way of example, this substrate may be a molten glass molding plate, or an injection-molding plate, using an epoxy resin, a silicone resin, or a composite resin thereof. As shown in FIG. 21(a), cylindrical through-holes 41 each having predetermined diameter and spacing therebetween are molded from one side of the green phosphor substrate by a transfer using a template. This plate forms the green phosphor region 21 (sea part).

Next, as shown in FIG. 21(b), the through-holes 41 are filled with a thermosetting resin 42 in which a predetermined concentration of the red phosphor is dispersed, by using the squeegee printing method or the like, and then the thermosetting resin is hardened. The resin being filled forms the red phosphor region 22 (island part).

Finally, as shown in FIG. 21(c), the substrate is cut into a size equivalent to or larger than the size of the light emitting element 3, by using the cutting blade 43 or the like, thereby producing the color conversion plate 5.

The semiconductor light emitting element 3 is mounted via flip-chip bonding on the substrate 1 which is prepared separately, by using Au bump 2. Thereupon, a transparent adhesive agent is coated to form a transparent adhesion layer 4, and the color conversion plate 5 produced by the steps above is mounted thereon.

Finally, a resin such as a thermosetting resin in which filler such as titanium oxide is dispersed, coats all over the side surfaces of the light emitting element 3 and the color conversion plate 5, by using a dispenser coating applicator or the like, and subsequently, it is hardened. According to the steps as described above, the light emitting device as shown in FIG. 19(a) and FIG. 19(b) is completed.

### Ninth Embodiment

As the light emitting device according to a ninth embodiment of the present invention, an explanation will be made as to the light emitting device employing an element which emits ultraviolet radiation.

In the eighth embodiment, an explanation has been made as to the device employing the blue light emitting element 3, and the device includes the color conversion plate 5 where the red phosphor regions 22 are scattered in the green phosphor region 21. It is further possible to configure such that the light emitting element which emits ultraviolet radiation is employed and the ultraviolet radiation is converted into red, green, and blue light by the color conversion plate, so as to emit white light which is obtained by mixing those colors.

For example, a phosphor (blue phosphor) is dispersed in the green phosphor region 21, in addition to the green phosphor, in the color conversion plate 5 of the eighth embodiment. Here, the blue phosphor emits blue fluorescence using the ultraviolet radiation as exciting light. Accordingly, the blue fluorescence is emitted from the region 21 being the sea part, in addition to the green fluorescence, and it is mixed in color with the red fluorescence emitted from the red phosphor region 22 being the island part, thereby outputting the white light.

It is further possible to provide a blue phosphor region in the green phosphor region 21, aside from the red phosphor region 22. The blue phosphor region is assumed as a region where the blue fluorescence is dispersed in a transparent resin, or the like. As a shape of the blue phosphor region, a cylindrical shape may be applicable, which penetrates in the color conversion plate 5 in the thickness direction, or a hemisphere shape or the like may also be applicable, a part of which is exposed on the upper surface of the color conversion plate 5.

The color conversion plate provided with such blue phosphor region is formed according to the following; in the production steps as explained in the eighth embodiment, the process until the step as shown in FIG. 21(c) is performed, thereafter, returning to the step shown in FIG. 21(a), and a cylindrically shaped through-hole or a hemispherical concave portion for the blue phosphor region is formed. Subsequently, such formed holes or concave portions are filled with blue phosphor dispersed resin by the squeegee printing method or the like in the step as shown in FIG. 21(b). Alternatively, in the step as shown in FIG. 21(a), a through-hole 41 serving as the cylindrically shaped concave portion may be formed for red phosphor region in the plate of the green phosphor region 21. And on the other surface, a cylindrically shaped or hemispherical shaped concave portion may be formed, which serves as a hole part for the blue phosphor region. With the configuration above, in the step as shown in FIG. 21(b), the through-hole 41 for the red phosphor region is filled with the red phosphor dispersed resin 42 from the surface on the side where there is no opening of the concave portion for the blue phosphor region, by the squeegee printing method or the like. Thereafter, the plate is turned upside down, and the concave portion for the blue phosphor region is filled with the blue phosphor dispersed resin by using the squeegee printing method or the like. Finally, in the step as shown in FIG. 21(c), the large-area plate is cut into individual color conversion plates 5.

### Tenth Embodiment

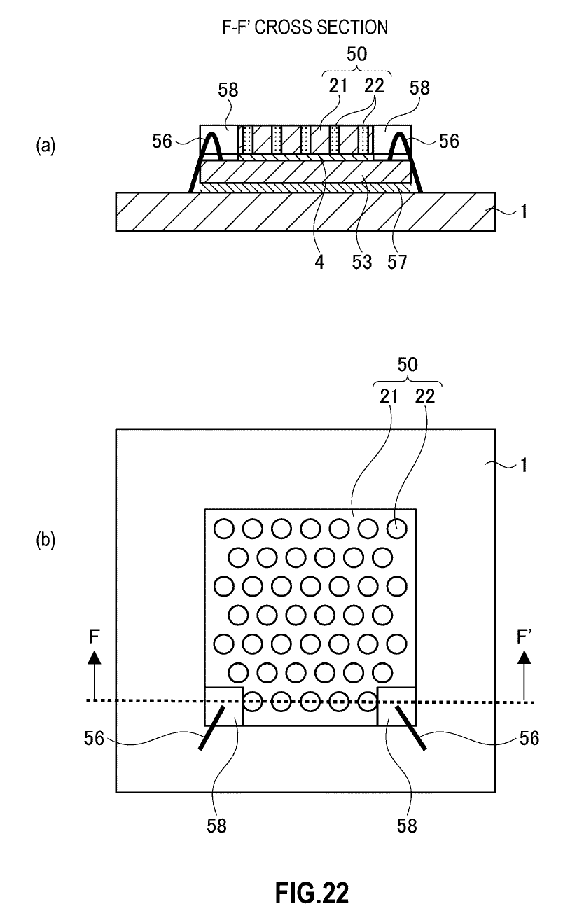

The light emitting device according to a tenth embodiment will be explained with reference to FIG. 22(a) and FIG. 22(b).

In the light emitting device as shown in FIG. 22(a) and FIG. 22(b), a semiconductor light emitting element 53 which emits blue light is implemented on the substrate 1 where electrode and wiring are formed in advance, via AuSn eutectic 57 and Au bonding wire 56. The color conversion plate 5 is bonded on the semiconductor light emitting element 53 via the transparent adhesion layer 4.

The semiconductor light emitting element 53 includes an element substrate and a light emitting layer formed thereupon. The semiconductor light emitting element 53 is a metal bonding (Metal Bonding: MB) element, therefore the element substrate is opaque to blue light. Hereinafter, in the tenth embodiment, the semiconductor light emitting element 53 is referred to as MB element 53. The MB element 53 is bonded to the substrate 1 by die bonding via AuSn eutectic 57, facing the element substrate to the substrate 1 side and facing the light emitting layer to the color conversion plate 5 side. An Au wire pad, not illustrated, is formed on the upper surface of the MB element 53, and it is connected to the electrode on the substrate 1 via the bonding wire 56.

Structures of the regions 21 and 22 of the color conversion plate 5 are the same as those in the eighth embodiment, but it is necessary that the regions 21 and 22 have to be arranged, avoiding the area where the bonding wire 56 is bonded on the upper surface of the MB element 53. Therefore, in the tenth embodiment as shown in FIG. 22(a) and FIG. 22(b), a notch 58 is provided on the edge of the color conversion plate 5.

A method for producing the color conversion plate 5 according to the tenth embodiment is the same as the production method of the eighth embodiment as shown in FIG. 21(a) to FIG. 21(c). However, in the present embodiment, when the green phosphor dispersed plate is subjected to die machining in the step of FIG. 21(a), the notch 58 is formed corresponding to the shape of the Au wire pad on the light emitting element 3 surface.

When the red phosphor region 22 being the island part is formed in the step of FIG. 21(b), the squeegee printing method or the dispenser coating method may be applied as in the case with the eighth embodiment. However, since a hole portion serving as the notch 58 is formed, it is preferable that masking is applied to the notch 58 with a film or a tape when the printing method is conducted. When the dispenser coating method is employed, it is applicable by producing programs, according to which a drop position from the dispenser device avoids the location of the notch 58.

In the step of FIG. 21(c), the large area plate is cut out by the cutting blade, thereby producing the color conversion plate where the notch 58 is formed.

An operation and effect of the color conversion in the light emitting device according to the tenth embodiment are the same as those of the eighth embodiment.

It is further possible to configure the light emitting device in the same manner as the tenth embodiment, by using the MB element which emits ultraviolet radiation and the plate which converts the ultraviolet radiation into three colors, as explained in the ninth embodiment.

The light emitting device according to the present invention may be applicable as an LED light source for a lighting system such as an LCD backlight, a general lighting, and a street light, for instance.

What is claimed is:

1. A semiconductor light emitting device comprising,
a light emitting element, and
a color conversion plate being mounted on the light emitting element, the color conversion plate containing at least a first phosphor and a second phosphor which absorb light emitted from the light emitting element and output fluorescence, wherein,
the color conversion plate has a sea-island structure including a sea region and an island region scattered over the sea region, and the island region contains the first phosphor and the sea region contains the second phosphor.

2. The semiconductor light emitting device according to claim 1, wherein,
a fluorescent wavelength of the first phosphor is a longer than a fluorescent wavelength of the second phosphor.

3. The semiconductor light emitting device according to claim 1, wherein,
a part of the island region is exposed on a surface of the color conversion plate on the light emitting element side.

4. The semiconductor light emitting device according to claim 3, wherein,
the island region has a convex shape in the upward direction with respect to the upper surface of the light emitting element, where an upper portion of the convex shape is embedded in the sea region and a bottom of the convex shape protrudes from the surface of the color conversion plate on the light emitting element side.

5. The semiconductor light emitting device according to claim 4, wherein,
the island region is shaped like a hemisphere, and a curved portion of the hemisphere is embedded in the sea region, and a bottom portion of the hemisphere is exposed on the surface of the color conversion plate on the light emitting element side.

6. The semiconductor light emitting device according to claim 3, wherein,
the island region is shaped like a sphere, and a portion of the sphere is embedded in the sea region and the other portion protrudes from the surface of the color conversion plate on the light emitting element side.

7. The semiconductor light emitting device according to claim 1, wherein,
the island region has a convex shape facing to the light emitting element from the surface of the color conversion plate on the light emitting element side, and a bottom of the convex shape is fixed on the surface of the color conversion plate on the light emitting element side.

8. The semiconductor light emitting device according to claim 7, wherein,
the island region is shaped like a hemisphere, the bottom of the hemisphere is fixed on the surface of the color conversion plate on the light emitting element side, and a curved portion of the hemisphere shape protrudes toward the light emitting element.

9. The semiconductor light emitting device according to claim 6, wherein,
a transparent adhesion layer made of a material being transparent at least to the light emitted from the light emitting element is arranged between the color conversion plate and the light emitting element, and a thickness of the transparent adhesion layer is equal to or larger than the height of the island region which protrudes from the sea region of the color conversion plate toward the light emitting element side.

10. The semiconductor light emitting device according to claim 3, wherein,
a second island region containing a third phosphor is scattered in the sea region, and a fluorescent wavelength of the third phosphor is shorter than the fluorescent wavelength of the first phosphor.

11. The semiconductor light emitting device according to claim 10, wherein,
the center of the second island region containing the third phosphor in the principal plane direction of the color conversion plate is located in such a manner as being displaced from the center of the island region containing the first phosphor.

12. The semiconductor light emitting device according to claim 10, wherein,
a part of the second island region is exposed on a surface which is opposed to the surface of the color conversion plate on the light emitting element side.

13. The semiconductor light emitting device according to claim 11, wherein
the fluorescent wavelength of the third phosphor is shorter than a fluorescent wavelength of the second phosphor.

14. The semiconductor light emitting device according to claim 10, wherein,
the second island region is shaped like a hemisphere, the curved portion of the hemisphere is embedded in the sea region, and the bottom portion of the hemisphere is exposed on the surface being opposed to the surface of the color conversion plate on the light emitting element side.

15. The semiconductor light emitting device according to claim 1, wherein,
the semiconductor light emitting element emits blue light, the first phosphor absorbs the blue light and emits red fluorescence, and the second phosphor absorbs the blue light and emits green fluorescence.

16. The semiconductor light emitting device according to claim 10, wherein,
the semiconductor light emitting element emits ultraviolet radiation, the first phosphor absorbs the ultraviolet radiation and emits red fluorescence, the second phosphor absorbs the ultraviolet radiation and emits green fluorescence, and the third phosphor absorbs the ultraviolet radiation and emits blue fluorescence.

17. A semiconductor light emitting device comprising,
a light emitting element, and
a color conversion plate being mounted on the light emitting element, the color conversion plate containing at least a first phosphor and a second phosphor which absorb light emitted from the light emitting element and output fluorescence, wherein,
the color conversion plate has a sea-island structure including a sea region and an island region scattered over the sea region, the island region penetrates into the color conversion plate in the thickness direction, and a part thereof is exposed on an upper surface and a lower surface of the color conversion plate, and
the island region contains the first phosphor, and the sea region contains the second phosphor.

18. The semiconductor light emitting device according to claim 17, wherein,
a fluorescent wavelength of the first phosphor is longer than a fluorescent wavelength of the second phosphor.

19. The semiconductor light emitting device according to claim 17, wherein,
the sea region contains a third phosphor in addition to the first phosphor, and a fluorescent wavelength of the third phosphor is shorter than a fluorescent wavelength of the first phosphor.

20. The semiconductor light emitting device according to claim 17, wherein,
a second island region containing a third phosphor is arranged, being scattered in the sea region, aside from the island region which contains the first phosphor, and a fluorescence wavelength of the third phosphor is shorter than a fluorescent wavelength of the first phosphor.

21. The semiconductor light emitting device according to claim 17, wherein,
the semiconductor light emitting element emits blue light, the first phosphor absorbs the blue light and emits red fluorescence, and the second phosphor absorbs the blue light and emits green fluorescence.

22. The semiconductor light emitting device according to claim 19, wherein,
the semiconductor light emitting element emits ultraviolet radiation, the first phosphor absorbs the ultraviolet radiation and emits red fluorescence, the second phosphor absorbs the ultraviolet radiation and emits green fluorescence, and the third phosphor absorbs the ultraviolet radiation and emits blue fluorescence.
